(19) United States
(12) Patent Application Publication
(10) Pub. No.: US 2015/0278732 A1
(43) Pub. Date: Oct. 1, 2015

(54) EMERGENCY SERVICES DISPATCH SYSTEM WITH DYNAMIC ROSTERING OF RESOURCES

(71) Applicant: CADMIUM SOLUTIONS, LLC, Platte City, MO (US)

(72) Inventors: GERHARD FIEDLER, Toronto (CA); GUILLERMO FUENTES, Niagara Falls (CA)

(73) Assignee: CADMIUM SOLUTIONS, LLC, Platte City, MO (US)

(21) Appl. No.: 14/227,324

(22) Filed: Mar. 27, 2014

(51) Int. Cl. G06Q 10/06; G06Q 50/26

(52) U.S. Cl. CPC G06Q 10/06312; G06Q 50/26

(57) ABSTRACT

A computer-aided dispatch (CAD) system that enables dynamic rostering of emergency services resources is disclosed. The CAD system includes a server system accessible by a plurality of access devices. The server system presents a plurality of web pages that enable a plurality of users using the access devices to: create a transfer order for a transfer event; create a virtual unit to fulfill the transfer order, wherein the virtual unit identifies one or more resource types required for the transfer event; and then roster the virtual unit by assigning one or more specific resources associated with the required resource types, whereby the assigned specific resources are dispatched to the transfer event.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention is related to the field of emergency services, and more specifically to the field of computer-aided dispatch of emergency services.

2. Description of Related Art

In the emergency services field, the dispatch and tracking of resources and assets such as personnel, vehicles and other equipment is essential for the efficient allocation and deployment of those resources. All emergency services, such as emergency medical services (EMS), police services, and fire services, require the utilization of different types of personnel and numerous types of vehicles and other equipment, all of which must be properly allocated in order to efficiently and accurately respond to particular emergency situations. While various systems and methods for dispatching emergency services have been used in the past, those systems have had limited degrees of success. For example, many smaller EMS and volunteer fire departments rely entirely on hand-written documentation regarding available resources and dispatch of those resources.

Computer-aided dispatch (CAD) technology is used by larger EMS, police, and fire departments. However, conventional CAD systems suffer from limitations as well. For example, most CAD systems are hard-coded in accordance with specifications provided by the particular emergency services company that will be using the CAD system. In the event of changes to the operation of that service—e.g., if the service expands into a new city—those hardcoded parameters must be changed, often at great expense. Hard-coded systems likewise allow limited flexibility in allocating and tracking resources. For example, many CAD systems currently used in dispatching EMS resources are programmed to allocate a specific number of personnel—e.g., a driver—to an ambulance. In actual operation, however, an ambulance may carry anywhere from one to three EMS responders or even more if it is a fire-based service. Thus, the CAD system cannot properly track and allocate the actual resources used in responding to the emergency situation and often cannot account for all EMS responders on a given scene.

Existing CAD technology is also lacking, at least in part, due to the disparate approach of the implementation (specifically the back end architecture of the system). In particular, most CAD systems require access to multiple databases, each of which contains information relating only to a narrow aspect of the emergency service and/or information duplicative of that found in another database. For instance, information relating to personnel is often stored in one database while information relating to equipment is stored in a separate database. As a result, the data may be stored across multiple databases (wherein all of the data in combination may be incomplete) and/or the same data may be stored in more than one database. This results in inefficient and incomplete allocation and monitoring of resources, which in turn can impact the quality of the services provided. The use of disparate databases also makes it difficult or impossible for the CAD system to properly locate and track the various resources used in connection with emergency services. Further, much of the data accessed by the CAD system cannot be updated by the CAD system operator and the ability to extract meaningful information from the CAD system becomes very difficult.

Another limitation on conventional CAD systems is that they often require and rely on specialized communications devices to communicate information between the communication center and the field resources, such as transmitters, radios, and transponders built specifically for use with the CAD system. This specialized equipment is generally expensive, and reliance on that special equipment greatly limits the options of an emergency services company in expanding or changing services.

### BRIEF SUMMARY OF THE INVENTION

The present invention is directed to a computer-aided dispatch system and method that provides an integrated solution to the dispatch and tracking of emergency services resources. In one aspect of the invention, the system employs an integrated database that aggregates all data required by the system into a single database, which is accessible by all users of the system and enables real-time updating of information by those users. The system is Web-based so that users can access all of the features and data using a standard web browser application running on common devices such as personal computers, tablets, or mobile devices, with no specialized equipment or software applications required. The system is intuitive and adjusts its views to the device so no appliances (information stored on a specific device) or device specific applications need to be run.

In another aspect of the invention, the system utilizes geolocation features to provide real-time tracking and location of emergency services resources. Geolocation is also utilized to define geofences, i.e., geographic areas in which particular resources are available (or restricted) to operate. The system also provides time-pattern scheduling of resources to define the times in which those resources are available, and qualification of resources to allow assignment only of resources meeting the criteria for the event for which emergency services are required.

In another aspect, the system enables real-time (i.e., on-the-fly) assignment and dispatching of resources to events so that personnel, vehicles, equipment and other resources are assigned dynamically only as needed. This feature of the system is referred to herein as “dynamic rostering.”

In yet another aspect, a holistic communications backbone is integrated into the CAD system to provide all users of the system with communication and messaging capabilities. The system sends notifications to users when they are assigned to respond to an event, and users can enter comments, photos, or other information into the system. All such communications are stored in the integrated database in association with the appropriate events.

### BRIEF DESCRIPTION OF THE DRAWINGS

Various exemplary embodiments of the present invention are described herein with reference to the attached drawing figures described below.

FIG. 1 is a block diagram of a computer-aided dispatch system in accordance with an exemplary embodiment of the present invention.

FIG. 2 is a block diagram of the data center of the system of FIG. 1.

FIG. 3 is an exemplary screen shot of an administrative web page as presented by the web server of the data center of FIG. 2.

FIGS. 4 to 9 are exemplary screen shots of web pages for user entry of emergency system resource information as presented by the web server of the data center of FIG. 2.

FIGS. 10 and 11 are exemplary screen shots of web pages for user creation of geofences as presented by the web server of the data center of FIG. 2.

FIG. 12 is an exemplary screen shot of a web page for user creation of time patterns as presented by the web server of the data center of FIG. 2.

FIG. 13 is an exemplary screen shot of a web page for user creation of resource qualifications as presented by the web server of the data center of FIG. 2.

FIG. 14 is a flow diagram of a method of performing a scheduled dispatch of emergency services resources in accordance with an exemplary embodiment of the present invention.

FIG. 15 is a flow diagram of a method of creating a unit in association with a scheduled dispatch of emergency services resources in accordance with an exemplary embodiment of the present invention.

FIG. 16 is a flow diagram of a method of rostering a unit in association with a scheduled dispatch of emergency services resources in accordance with an exemplary embodiment of the present invention.

FIGS. 17-22 are exemplary screen shots of web pages for the scheduled dispatch of emergency services resources as presented by the web server of the data center of FIG. 2.

FIG. 23 is an exemplary screen shot of a notification provided to a user of a mobile device.

### DETAILED DESCRIPTION OF EXEMPLARY EMBODIMENTS

The present invention is directed to a system and method for computer-aided dispatch (CAD) of emergency services. As used herein, “emergency services” encompasses emergency medical services (EMS), police, fire, and other emergency first-responder services. While the invention will be described in detail below with reference to various exemplary embodiments, it should be understood that the invention is not limited to the specific system configurations or methodologies of these embodiments. For example, although an exemplary embodiment may describe a specific vehicle used in conjunction with emergency medical services (EMS), it should be understood that the invention may equally be used with other emergency services, such as fire or police dispatch, in which case the personnel, vehicles and equipment will vary from those described in the exemplary embodiment. In addition, although the exemplary embodiments are described as embodying several different features, one skilled in the art will appreciate that any one of these features could be implemented without the others, or may be implemented in combinations other than those specifically described, all in accordance with the present invention.

In one aspect of the invention, the CAD system is web-based and thus accessible to authorized users via any device capable of running a standard web browser application, wherein the access rights of each user determines whether the user has access to more or less features of the system. In another aspect, the CAD system maintains a single integrated database in which all information is stored for access by the system. In another aspect, the CAD system associates timestamp and/or geolocation information with data records as they are stored in the database to allow real-time tracking and correlation of emergency services resources. The geolocation information is used in conjunction with mapping services to allow the display of resources on a map display. In another aspect, the geolocation information is used in conjunction with user-defined geofences that define geographic areas that can be associated with system resources to allow or restrict allocation of those resources. These geofences are created by a user with the proper authority so as to enable the user to define work zones on the fly, as well as activate and deactivate the geofences as needed. System resources likewise may have associated time patterns (i.e., times in which the resources are available) and associated qualifications (i.e., criteria for use) that can also restrict or otherwise determine if those resources are available to be allocated for a given event.

In another aspect of the invention, the CAD system is event driven. That is, the dispatching and allocation of emergency services resources is comprised of one or more events which are assigned or scheduled by users of the system (e.g., dispatchers) and those events are noticed to other users of the system (e.g., EMS responders). This capability flows from the system architecture in which all data is preferably stored in a single database and all users simply have different views of the data in the database. The geolocation capabilities and real-time tracking of resources enables dynamic rostering, i.e., on-the-fly allocation and assignment of the emergency services resources.

In yet another aspect of the invention, a communications backbone is integrated into the CAD system that allows conversations (i.e., communications, comments, documents, photos, or other information) to be associated with events, and allows communication to, from, and between users of the system. Conversation data is likewise stored in the database and is accessible in real-time by users of the system.

The various aspects described generally above, one or more of which may be incorporated into a CAD system in accordance with the present invention, will be described in greater detail below with reference to the exemplary embodiment shown in FIGS. 1-25.

System Configuration

Referring to FIG. 1, an exemplary system for the computer-aided dispatch of emergency services in accordance with an exemplary embodiment of the present invention is shown generally as reference numeral 10. System 10 includes a data center 12 that hosts a web-based computer-aided dispatch (CAD) system associated with each of one or more emergency services companies responsible for administering and dispatching emergency services such as EMS, police and/or fire services. Each CAD system is implemented using basic World Wide Web standards for the coding and transmission of hypertext documents. These standards include various versions of HTML (hypertext mark-up language) and HTTP (hypertext transfer protocol), including HTML5 which is suitable for use with mobile devices. Of course, data center 12 may alternatively be operated directly by an emergency services company instead of the hosted model of the exemplary embodiment.

For simplicity, data center 12 is depicted in FIG. 1 as hosting a CAD system associated with a single emergency services company. The CAD system is accessible by a plurality of users via the Internet using an access device such as a personal computer (PC), tablet, or mobile device. Each user access device runs a web browser application that enables retrieving, presenting and traversing information resources on the Internet. In particular, the web browser application allows the user access device to access the web pages of the CAD system. As will be described in more detail below, the CAD system enables the assignment, dispatch, and monitoring of emergency services resources as well as the monitoring and updating of information relating to such resources by the various users of the system.

Looking still to FIG. 1, the users accessing the website generally include one or more system administrators 16 (e.g., individuals responsible for maintaining and operating the system under the direction of an emergency services company), one or more dispatchers 18 (e.g., individuals responsible for using the system to dispatch emergency services as required), and one or more emergency services personnel 20 (e.g., individual emergency personnel, such as an EMS paramedic, fireman, or police officer).

It should be understood that each user shown in FIG. 1 may comprise a single user, a plurality of users, or a group of users. For example, the dispatchers 18 may be an individual dispatcher or may comprise a group of people responsible for dispatching emergency services. That group of people may be co-located in a dispatch center, or may be located in geographically disparate locations. Likewise, the emergency services personnel 20 may comprise an individual user such as a paramedic, or may comprise a group of users such as an ambulance crew in which each crew member may be a user of the system or the crew may rely on a single user in the group. It should be understood that the users depicted in FIG. 1 are exemplary of typical users of the CAD system, and that any particular emergency services company setup or dispatching situation may involve more or fewer users than depicted, or may involve users others than those specifically depicted or described. These and other variations are within the scope of the present invention.

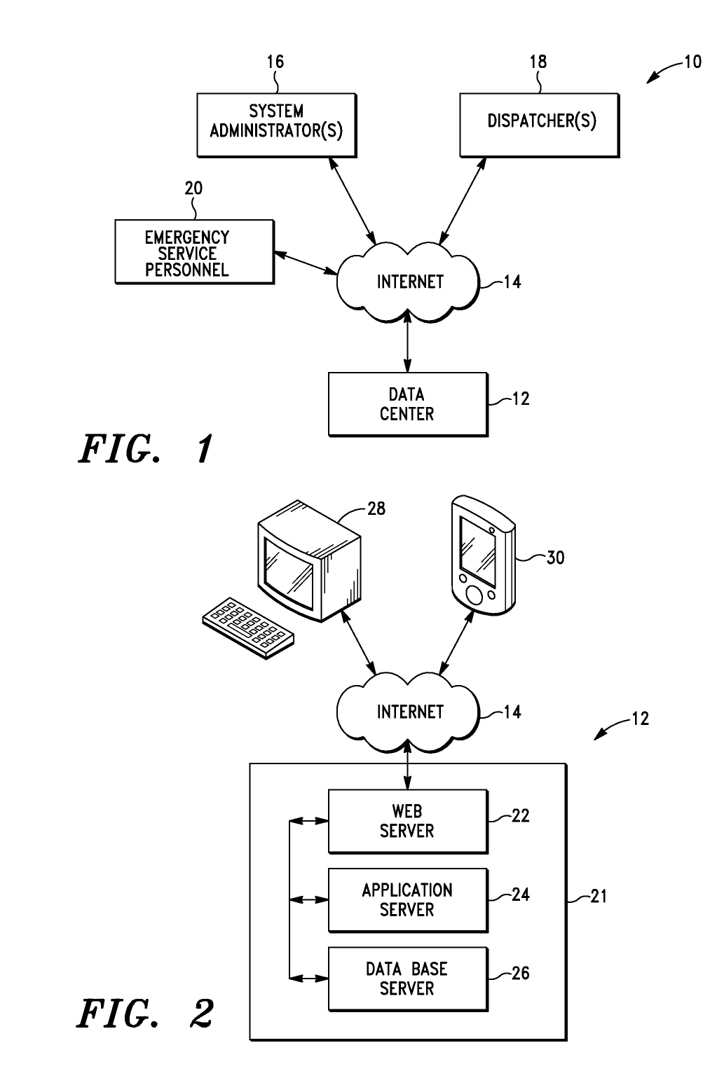

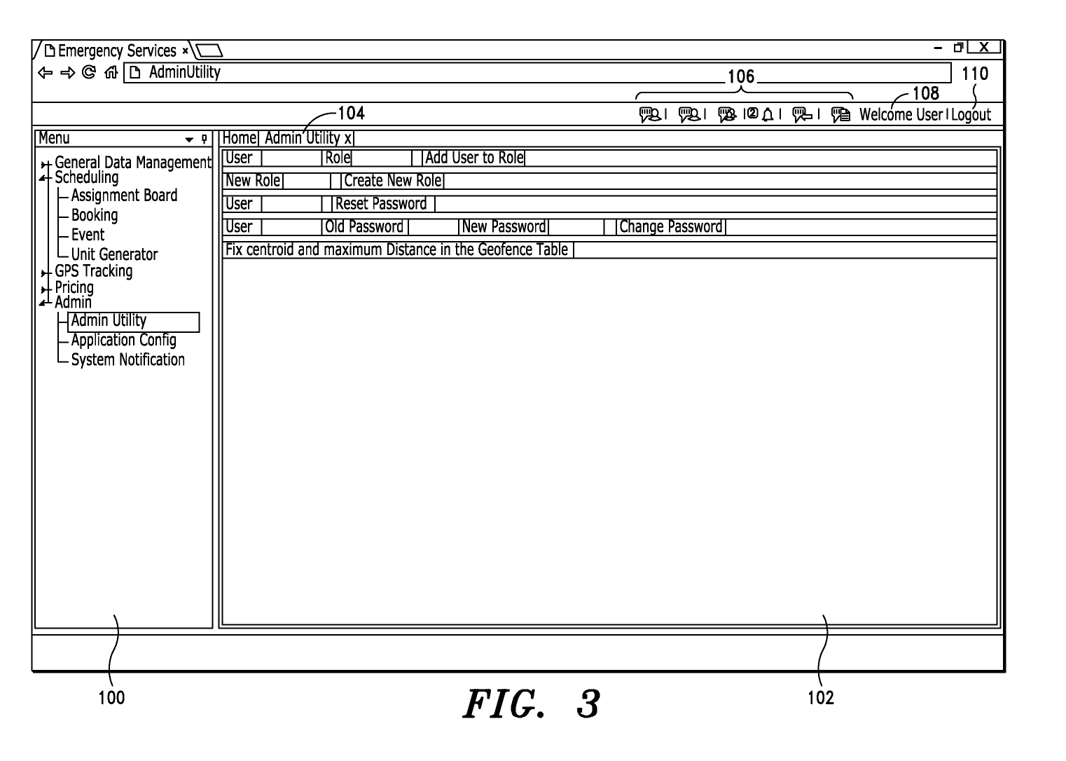

Looking to FIG. 2, an exemplary embodiment of the data center 12 (which hosts the CAD system of one or more emergency services company) is depicted. The data center includes a server system 21 comprising a web server 22, an application server 24, and a database server 26, all of which are in communication with each other via any suitable bus or communication system. In the exemplary embodiment, the data center 12 is preferably hosted in Windows Azure, using MS SQL, Windows Server 2012, and Internet Application Server. One skilled in the art will understand that the configuration of the data center 12 and hosting arrangement may be varied within the scope of the present invention.

As will be described in greater detail below, web server 22 is connected to the Internet 14 and includes a user interface that presents various web pages of the CAD system to the users, and, includes functionality for the users to input data into various data input fields displayed on the web pages. The application server 24 runs a CAD application that provides various types of functionality for the CAD system, such as dispatching, tracking, and administrative capabilities. The CAD application may be implemented in different languages, and may comprise groups of programs or subprograms. It should be apparent to one skilled in the art that users are able to utilize the various capabilities of the CAD application via the user interface of the web server 22.

The application server 24 is in communication with the database server 26, which stores data relating to the various events, personnel, equipment, and other items associated with the dispatch of emergency services using the CAD system. Preferably, all data relating to an emergency services company is stored in a single integrated database such that the CAD application has real-time access to all data at all times, including data relating to the dispatch, assignment, and tracking of all personnel, equipment, and other resources of the company. Of course, while not preferred, certain aspects of the invention may be implemented by a system that utilizes a plurality of databases in the CAD system.

Users of the system (such as the system administrators 16, dispatchers 18, and emergency services personnel 20 described above) access the CAD system via the Internet 14 using personal computers 28 or mobile devices 30 running a web browser application to access the web pages presented by the web server 22. It should be understood that any device capable of running a suitable web browser application may be used to access the CAD system, as is well known in the art. Preferably, the personal computers 28 and mobile devices 30 include geolocation capabilities to provide location information in association with the transfer of information to the CAD system. The geolocation capabilities may be in the form of GPS chips in mobile devices, geolocation using the IP address of a device, or other methods known in the art.

It should be understood that the web server 22, application server 24, and database server 26 may either be co-located or dispersed at various locations. The present invention also encompasses the deployment of backup servers and parallel servers to increase the traffic handling capabilities of the system. Similarly, while the present invention preferably stores all data in a single integrated database, that database may be backed up or duplicated to other database servers or RAID drives or may be hosted on various database servers as is known in the art.

Because the CAD system is hosted at data center 12 and accessed through a standard web browser, users may access the system using common, off-the-shelf computing devices running a web browser application. The user access devices are not required to run any special applications and users are not required to install any appliances or other software modules on their devices. Also, there is no data stored on the user access devices. Thus, the CAD system maintains privacy and is compliant with various privacy standards, such as HIPPA standards. Preferably, the data stored in database server 26 is encrypted, further ensuring the secure storage of that data.

Furthermore, because the user access devices comprise off-the-shelf computing devices, there is no need for special communications equipment in order to access or use the CAD system. Each user simply needs a computing device running a web browser application. There are no special walkie-talkies, communicators, transponders, or any other specialized equipment that an emergency services company must acquire or assign to users in order to access or use the CAD system. Similarly, any user can choose to upgrade or change the device used to access the CAD system. As long as the new device can connect to the Internet and run a web browser application, the user can continue to access the CAD system using her same assigned username and password (or other type of access credentials).

In a preferred aspect, all data is stored in a single integrated database, which enables the CAD system to provide an integrated display of any combination of such data. Thus, unlike conventional CAD systems that rely on different databases and different displays to track the various types of information, the CAD system of the present invention presents all of the information on a single display available to the users of the system.

System Operation

Referring again to FIGS. 1 and 2, data center 12 preferably hosts a secure website wherein each user is assigned a user name and a password (or other type of access credentials) by a system administrator 16 to allow access to the CAD system. As is known in the art, a user accessing the CAD system will first be presented with a login web page requesting entry of a user name and password. If the entered user name and password match those of an authorized user, that user will be allowed access to the CAD system with the restrictions or authorizations associated with that user (i.e., a user's “role”). The user will be initially directed to a common welcome page, or may alternatively be directed to a particular web page, depending on the role of the user or any default preferences set by that user as is known in the art. For example, as described below, a dispatcher 18 may be initially directed to a “Booking” page, while a system administrator 16 may be initially directed to an “Admin” page.

The access rights for each user of the CAD system may be unrestricted or restricted in some manner. For example, a system administrator 16 may have nearly unrestricted rights to access any area of the CAD system, while emergency services personnel 20 may have restricted rights that enable them to access only those features and data necessary to perform their specific jobs. Similarly, the access level or role of a user of the CAD system may be used to alter the appearance of the web pages presented to that user, or to omit items from a particular web page so that the user is not even presented with particular unauthorized features. For example, a function not available to a particular user may be “greyed-out” on the web page presented to that user (so that she cannot select that function), or may not be presented at all. These types of authorization and access control are well known in the art.

Likewise, the presentation and manipulation of web pages is well known in the art and will not be described in detail with respect to the exemplary screen shots described below. For example, it is known to present a navigation pane in a web page that presents a menu structure and allows a user to jump to a specific portion of the website or application and/or to expand and collapse that menu structure. It is also known to present multiple panes on a web page, with the user allowed to expand, collapse, rearrange, and otherwise manipulate the appearance of the web page as desired. Thus, when viewing a map presentation in a pane of a web page, a user may desire the view to be larger and may choose to collapse other panes to accommodate the larger map. Furthermore, one skilled in the art will understand the use and functionality of data input boxes, data tables, buttons, drop-down menus, and other features well known in the presentation and manipulation of web pages and in the entry of data on web pages.

As described above, users may access the website using mobile devices running web browser applications. As is known in the art, mobile web browser applications (particularly those compliant with HTML5 standards) may automatically resize and reconfigure various web page items to conform to the size and display attributes of the particular mobile device, including the presentation of menus and selection items. Thus, in the description of exemplary screen shots as presented herein, those known functions and potential variations in display will not be described in further detail. It should also be understood that the screen shots presented are exemplary only, and that variations in the appearance, sequence, orientation, and presentation of those screen shots are within the scope of the present invention.

It will be seen that the web pages presented by the CAD system include various data input boxes and fields, drop-down menus, buttons, icons, and other known mechanisms that allow the CAD system to receive input from users and provide output data to users. To the extent that particular inputs, outputs or other features on a web page are necessary for implementation of the invention, those features will be discussed herein. To the extent that such features are not required or are ancillary or well known in the art, they will not be discussed in detail.

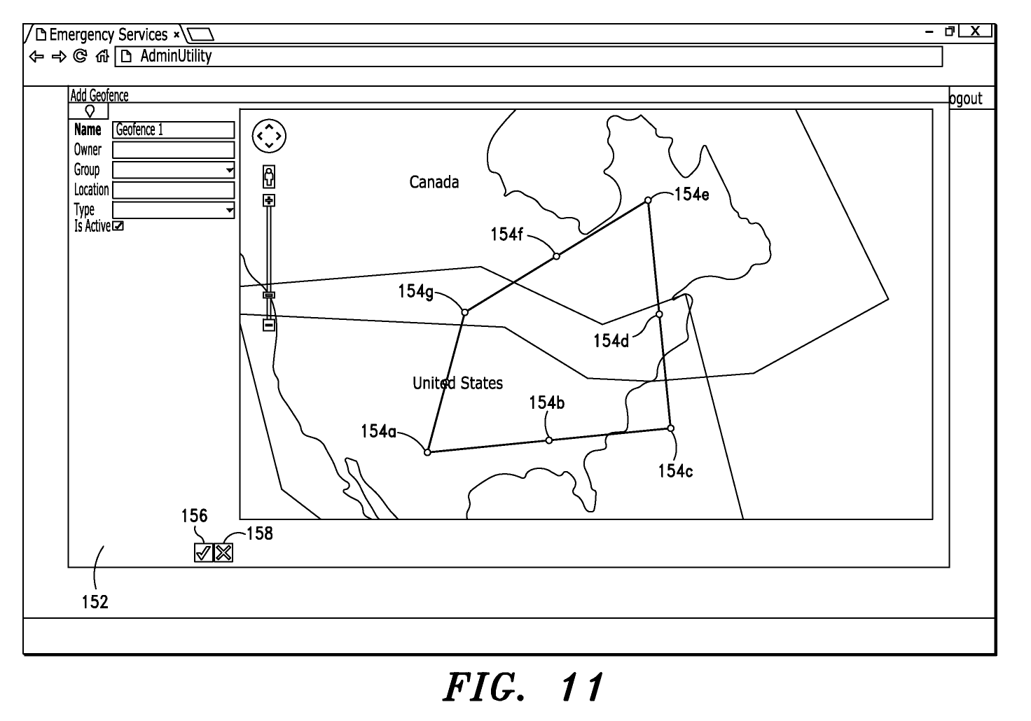

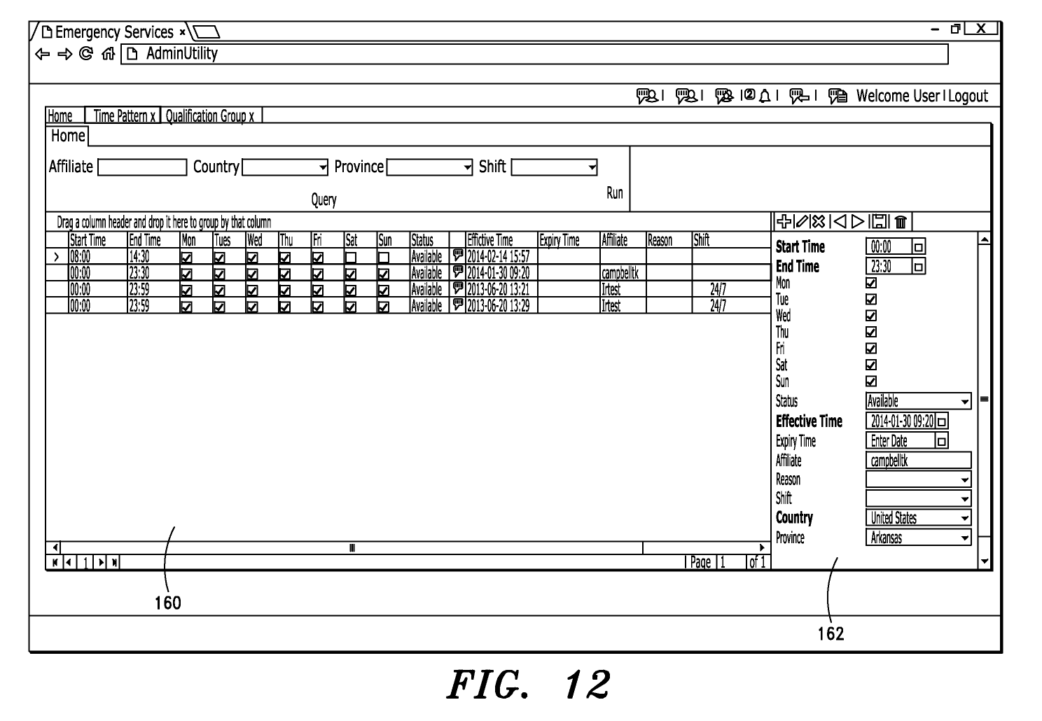

Many of the web pages presented by the CAD system allow input of detailed information relating to a particular record. In most cases, only a few of those inputs are required by the CAD system, and the required items are typically identified by bolding the label on the input box for that data item on the web page. For example, when defining a geofence as depicted in the screen shot of FIG. 11 (discussed below), the only information required to be entered in the data input fields is a “Name” for the geofence—that “name” label is shown in bold on the web page. The information not required by the CAD system is typically informational in nature, and those fields may be configured or altered by a system administrator to capture information relevant to the emergency services company operating the CAD system. Thus, those ancillary data fields will not be discussed in detail herein.

Turning now to FIG. 3, an exemplary “Admin” web page is depicted that may be the initial page presented to a system administrator and which presents many features common to all web pages of the CAD system. While those common features will be identified with reference to the exemplary web page of FIG. 3, it should be understood that all of the web pages will display similar or identical features. It should be further understood that while all of the common features will be identified and described with reference to this and other exemplary web pages, for the purposes of clarity and brevity, not every common feature will necessarily be described or identified with respect to every web page on which that feature appears.

As shown in FIG. 3, the “Admin” web page includes a navigation pane 100 positioned along the left hand side of the page. As is known in the art, the navigation pane presents a menu structure of various sections of the CAD system and allows a user to navigate the CAD system by selecting the desired component using a mouse, touchscreen, or keystrokes to point to and select a section listed in the menu structure. Selecting a section or sub-section causes the CAD system to jump to that selected section or sub-section and display the web page corresponding to that section or sub-section. As is known in the art, sections of the navigation menu can be expanded or collapsed to show or hide the sub-sections within that module. Thus, in some of the web pages discussed herein, the navigation menu may be collapsed to provide a better view in another pane of the depicted web page.

As is also known in the art, additional navigation controls may be presented on various web pages. For example, as discussed below, an “Assignment Board” web page includes a “Booking” icon that causes the application to jump to that “Booking” section of the CAD system. Thus, a user at the “Assignment Board” page may (and likely would) use that icon to navigate to the desired “Booking” page, or may choose to use the navigation pane as just described to select the “Booking” page from the navigation menu. Similarly, common display controls and icons appearing on depicted web pages will be familiar to those skilled in the art, and may not be described in further detail. For example, forward and back arrow icons used to scroll through a presented data list, an icon depicting a floppy disk used to save a record, an icon depicting a trash can used to delete a record, and so forth are well known in the art and will not be described in detail.

Referring again to the navigation pane of the web page depicted in FIG. 3, it can be seen that the CAD system generally includes “General Data Management,” “Scheduling,” “GPS Tracking,” “Pricing” and “Admin” sections and associated web pages, with each of those having sub-sections and sub-pages that can be accessed through the navigation pane. It can also be seen that the web page depicted in FIG. 3 is associated with the “Admin” section, and specifically the “Admin Utility” web page (as highlighted in the navigation pane).

While the sections identified in the navigation pane generally group the functionality of the web pages of the CAD system, it should be understood that the operation and flow of the CAD system is not linear and thus does not require a user to systematically step through every web page of every available section. Instead, the operation of the CAD system is free-flowing and dynamic so that a user can navigate between the web pages most relevant to that user's role. In most cases, a user can access or jump to a desired web page by clicking a link appearing in another web page, or the CAD system will automatically navigate a user to the next appropriate web page when a user completes or enters a record. Thus, it should be understood in the sequence of exemplary web pages presented herein that a user may access those web pages in various ways, and that the specific sequence of those web pages depicted is exemplary only.

Looking still to FIG. 3, the web page also includes a data input pane 102 that presents fields for data input by a user. While the web page shown in FIG. 3 presents a single data input pane, other web pages depicted herein may include two or more data panes to present various combinations of input and output data in various forms. For example, many of the user panes will display graphical representations of maps and information presented in relation to that map in a data pane on the web page.

A locator indicator tab 104 is positioned just above and towards the left of user pane 102. The locator indicator tab appears on most of the web pages to indicate the specific web page that is being displayed, i.e., in this case the page is the “Admin Utility” page. A “Welcome User” tab 108 appears at the upper right portion of the web page identifying the user currently logged into the system, with an adjacent “Logout” button 110 that allows a user to logout and exit from the CAD system.

Positioned above and towards the right of user pane 102 are a series of icons 106 associated with the conversation feature of the CAD system (described in more detail below). The icons generally alert a user as to any messages directed to her (e.g., a notification that the user has been assigned to a call or transfer event). From left to right, the icons indicate: Urgent Action Required (which indicates the number of conversations that have been directed to the user and require urgent action); Action Required (which indicates the number of conversations that have been directed to the user and require action); CC: Conversations (which indicates the number of conversations that have been directed to someone else and copied to the user); Follow Ups (which indicates the number of reminders, i.e., follow-ups, that are pending for the user); Replies (which indicates the number of replies from other users that have been received by the user); and Expected Urgent Replies (which indicates the number of expected replies to an urgent conversation sent by the user).

System Setup

A user of the CAD system will initially perform some level of setup of the system. That initial setup generally requires assigning and setting up authorized users of the system and setting up initial emergency services resources in the database along with any associated geolocation, time pattern, and qualification restrictions applying to those resources. It should be understood that subsequent entry of resources into the database is essentially identical to the initial entry of data, that is, a user is simply adding another resource to the existing database. Thus, when describing the entry of new data into the database below, it will be apparent that the database already includes some data entries in the exemplary web pages presented.

Setup Users

As is known in the art, a system administrator for the emergency services company that is operating the CAD system will typically be given a master system administrator username and password that allows full access to the CAD system. That access allows her to initially configure the system and database and to assign additional users (including additional system administrators) of the system.

Looking still to the “Admin” web page of FIG. 3, it can be seen that the pane presents four lines of data input fields and buttons, as follows: fields for “User” and “Role” with an associated button for “Add User to Role”; a field for “New Role” with an associated button for “Create New Role”; a field for “User” with an associated button for “Reset Password”; and fields for “User,” “Old Password” and “New Password” with an associate button for “Change Password.”

It should be apparent to one skilled in the art that the presented user fields allow a user to enter data relating to that field, whereby selection of the button associated with that field will cause the data to be stored in the database for use in the CAD system. It should also be understood that any data input to the CAD system (i.e., any data entered into an input field, and an associated button clicked to accept that data) will cause the CAD system to store that data by accessing the database, creating a new record to receive and store that data, and writing that information into the database. Or, in the case of editing data of an already existing record, entry of the data causes the CAD system to access the database and overwrite the old data with the new data in the existing record. For example, data entered by a dispatcher creating a new event will cause the CAD system to access the database and create a new record to store that event and associated data, while a system administrator changing an existing paramedic's contact information will cause the CAD system to access the database and overwrite the old information in the existing record with the new information.

Using these input fields, a system administrator can authorize additional users by assigning a user name, password, and role for each new user, or may change an existing user's password or role. A user's role is analogous to an authorization level, i.e., access to various functions and features of the CAD system may be restricted by a user's role as discussed above.

In the exemplary embodiment, with reference to FIG. 1, a system administrator may set-up additional users with the role of system administrator, may set-up users with the role of dispatcher, and may set-up users with the role of emergency services personnel, with each of those roles having a specific authorization or access level to various features and functions of the CAD system. As is known in the art, a system administrator can further restrict or allow access to various system features on a per-user basis, i.e., she can alter a user's authorizations in addition to the authorizations set by a user's role. Furthermore, it should be understood that the role parameter, as with most other parameters used in the CAD system, is user-definable. Thus, a system administrator may choose to define the roles for its CAD system as “master user,” “mobile user,” etc., and define the desired authorizations to those named roles. In other words, the CAD system does not dictate the specific labels given to users of the system.

Setup Resources

With authorized users of the system setup as just described, a system administrator of the CAD system next enters the emergency services resources for the emergency services company into the database, i.e., resources that can be allocated to perform required emergency services. Emergency services resources typically comprise people (e.g., doctors, nurses, EMS personnel, etc.), facilities or locations (e.g., hospitals, clinics, EMS stations, air strips, etc.), vehicles (e.g., ambulances, fire trucks, etc.), and other equipment (e.g., stretchers, oxygen tanks, etc.). While other emergency services assets (e.g., consumables such as bandages, medicines, etc.) may be employed in the course of operating an emergency services company, the exemplary embodiment presented herein will primarily discuss the basic resources—people, facilities/locations, vehicles, and equipment. It should be understood that the CAD system is capable of dispatching and tracking any other such EMS resources (or other emergency response personnel such as fire or police).

People and entity resources are collectively referred to as “affiliates” in the CAD system. For example, an entity owning a hospital or hospitals is an affiliate, as is a pilot of an air vehicle used to transport patients. Affiliates may be associated with one or more other affiliates and with one or more locations, vehicles or other equipment. Thus, for example, a hospital owner affiliate may be associated with numerous hospital and clinic locations, numerous doctors, nurses or other personnel, and may be associated with numerous vehicles. Similarly, any particular resource may be associated with one or more affiliates, e.g., a doctor may be associated with more than one hospital facility.

Affiliate associations provide a way of grouping and associating the various resources for easier understanding by a user of the CAD system. For example, a dispatcher can easily identify all resources associated with a particular hospital affiliate, or can easily identify which hospitals a particular doctor is associated with. All affiliate association information is stored in the database in association with the records relating to those resources.

A system administrator setting up the CAD system for a particular emergency services company would thus typically need to enter data for the resources available to that company. Exemplary resources include one or more people (i.e., affiliates, such as doctors, nurses and pilots), one or more locations (e.g., hospitals, clinics, or air strips), one or more vehicles (e.g., ambulances or air transport vehicles) and one or more pieces of equipment (e.g., oxygen tanks or stretchers). The system administrator enters all resources in a similar manner.

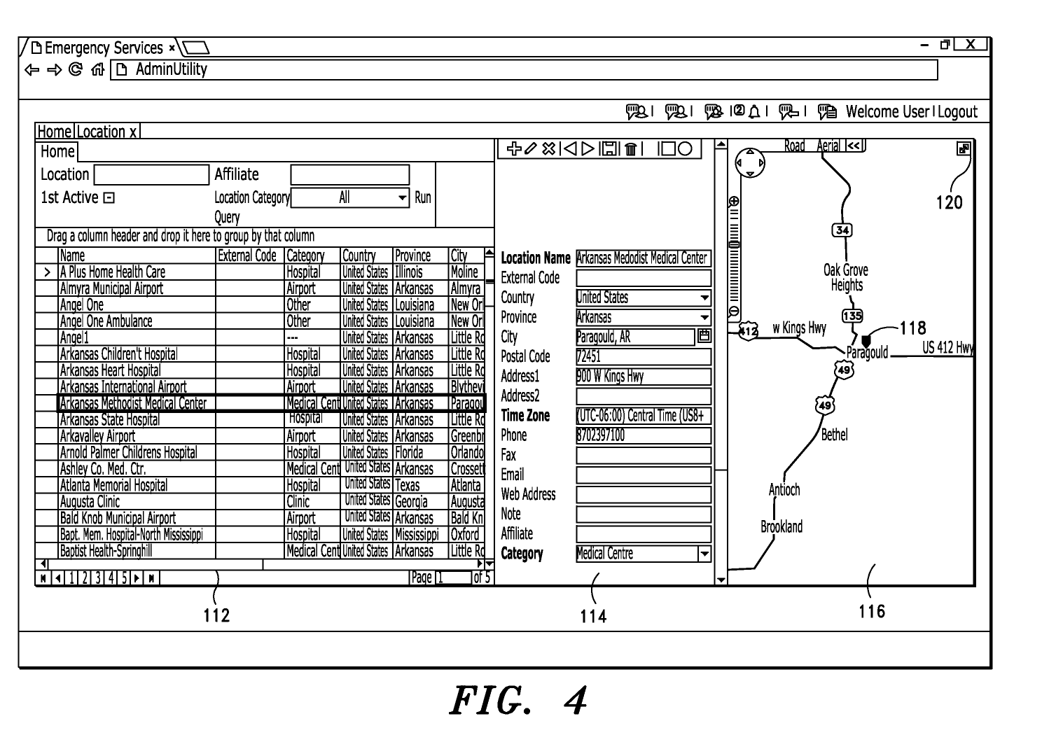

For example, referring to FIG. 4, a screen shot of an exemplary “Location” web page for entry of information relating to a location, such as a hospital or clinic, is shown. To enter location information, a system administrator navigates to the “Location” web page using the navigation menu of the CAD system as previously described. The “Location” page presents three panes of information—at the left hand side of the page is a data query pane 112, in the center of the page is a data entry pane 114, and at the right hand side of the page is a mapping pane 116. As previously described, the sizes of each pane can be varied by the user, individual panes can be collapsed, and the overall arrangement of the web page can be altered by the user as is known in the art.

The left-hand data query pane 112 presents a list of locations stored in the database in a columnar format. The columns present the name of the location (i.e., the name of the facility), external code (i.e., a user-defined code to group locations), category (i.e., the type of facility), country (i.e., the country in which the facility is located), province (i.e., the province or state in which the facility is located), and city (i.e., the city in which the facility is located).

A user can filter the locations displayed using the query functions displayed at the top of the data query pane 112, or sort the data using the columnar controls. For example, a user can sort the displayed data columns in ascending or descending order by clicking on the desired column heading, and can vary the width of the columns to display more or less information. Using the query search boxes at the top of the pane, a user can search for location names that match an entered location name (e.g., enter a specific name in the “location” input box) or that match an entered affiliate name (e.g., enter an affiliate name in the “affiliate” box). As user can also select a location category from the drop-down menu (e.g., select “hospital,” “clinic,” etc.). With the desired filter criteria selected, a user clicks the “Run” icon to execute the query and the CAD system accesses the database and retrieves and displays only those records matching the query criteria. The data display and query functionality are common to numerous web pages in the CAD system and will be familiar to those skilled in the art.

The center data entry pane 114 allows a user to enter a new facility/location, or to edit an existing record. Using the icon buttons at the top of the pane, a user can add a new record (e.g., click the “+” icon and enter the new information), edit an existing record (e.g., click the pencil icon and change the information in the data input boxes), navigate through the records (e.g., using the forward and back arrows, which accomplishes the same function as scrolling through the data records in the left-hand query pane), save any entered changes (e.g., click the floppy disk icon), or delete a record (e.g., click the trash can icon). The functionality of adding, deleting, and editing records using the icons and display panes is similarly implemented in other web pages of the CAD system and will be familiar to those skilled in the art.

A system administrator adding a new facility/location clicks the “+” icon to begin entry of information for the new record. The information entered must include at least a location name, a time zone, and a category (i.e., the fields that are bolded on the data entry pane). The remainder of the information (e.g., address, phone, fax, email, web address, etc.) is optional, although entry of an address is preferred to allow the CAD system to automatically obtain geographic coordinates for the facility/location as described in more detail below. This data entry format (with required information fields indicated in bold) is common to many web pages in the CAD system.

When the desired information for the new record is entered, the user clicks the floppy disk icon to save that record, causing the CAD system to access the database and store the information in a new record. When the new record is entered, it is immediately accessible in the database and is thus immediately available to all users of the system. Depending on the query criteria currently in use in the data query pane 112, that new record will also be immediately displayed in that pane.

Referring to the mapping pane 116, it can be seen that a map image of the geographical area of the location of the facility/location is displayed. The map image and locator pin icon 118 (showing the specific location of the facility/location) displayed in the pane are obtained from a commercial mapping service such as Google Maps or Bing Maps. As is known in the art, in response to receipt of one or more sets of geographic coordinates (i.e., latitude and longitude coordinates of a facility/location), the mapping service provides map and locator pin location information for display within the user's web browser, window, or pane. Thus, in the example shown in FIG. 4, with the “Arkansas Methodist Medical Center” facility/location selected, the CAD system sends the geographical coordinates (latitude and longitude) of that facility to the mapping service and then directs the mapping data received from that mapping service to the mapping pane for display to the user.

Controls presented in the mapping pane 116 allow a user to zoom in or out on the displayed map. A user can also move the map within the pane by clicking and dragging, as is known in the art. A “Best View” icon 120 in the upper right portion of the pane causes the map display to scale and center the display around the facility/location (or locations, in cases where more than one facility/location is displayed on the map at the same time, as will be the case in other web pages discussed below). These mapping manipulation and orientation controls will be familiar to those skilled in the art.

Every facility/location resource preferably has its geographic coordinates (i.e., latitude and longitude) stored as part of its data record. In addition to providing map displays as just described, the mapping service also provides geographic coordinates to users of the service. When a user enters a street address for a new facility/location, such as in the data entry pane 114, that address is sent to the mapping service. The mapping service translates the address to a set of geographic coordinates (i.e., latitude and longitude) which is returned to the CAD system. The CAD system captures the latitude and longitude coordinates for that facility/location and stores them in the database in association with the data record for that facility/location. Thus, for subsequent displays of that facility/location on a map (e.g., when a user goes to the “Location” page and selects a facility/location that has already been entered), the CAD system retrieves those previously obtained and stored geographic coordinates and sends those to the mapping service which then provides the mapping display to the user. As will be discussed in more detail below with respect to the geofences aspect of the invention, the mapping service also provides the geographic coordinates of points selected by a user on a map, i.e., a user can point and click to select a location on the map rather than enter a street address.

As is known in the art, and as is common to other web pages depicted herein, the three panes work in conjunction to display information about the location. For example, as shown in FIG. 4, with a facility/location selected in the left-hand data query pane 112 (e.g., the “Arkansas Methodist Medical Center”), the detailed information for that selected facility is presented in the center data entry pane 114 and populated into the data input boxes in that pane, and the geographical location of that facility is displayed in the right-hand mapping pane 116.

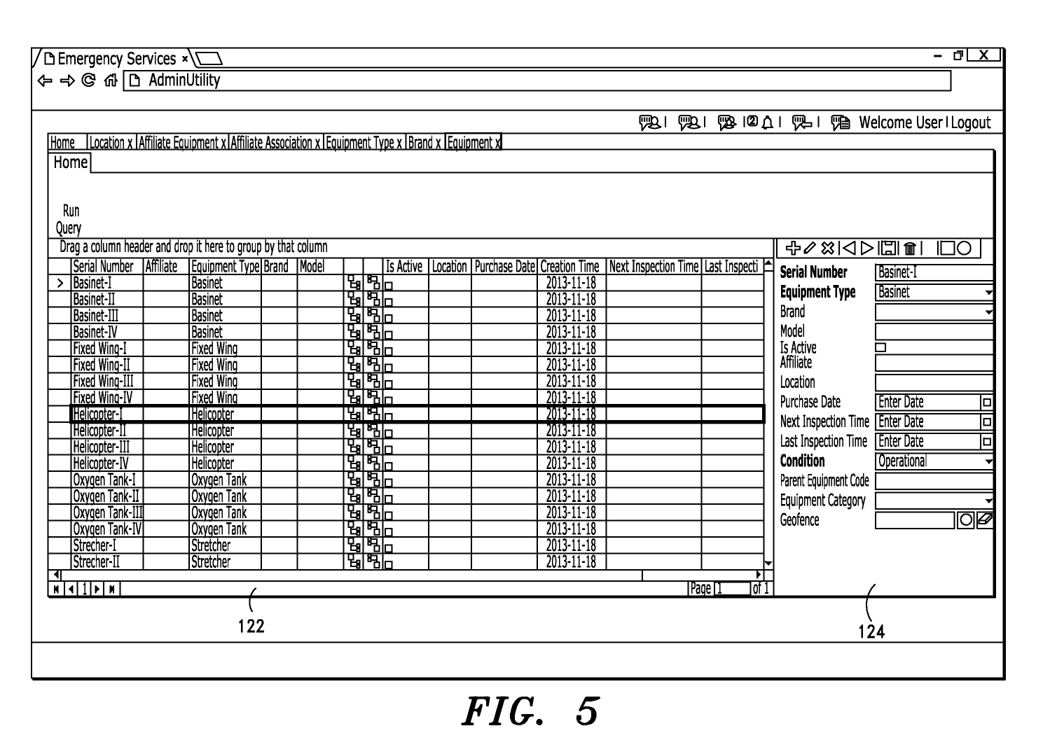

Looking now to FIG. 5, the process of entering vehicles and other equipment is similar to process of entering a facility/location as just described. Specifically, a user navigates to the “Equipment” page shown in FIG. 5 using the navigation pane previously described. That page presents two panes to the user—a data query pane 122 on the left-hand side of the page, and a data input pane 124 on the right-hand side of the page. Any equipment records already stored in the database are retrieved from the database by the CAD system and displayed in the data query pane 122. As previously described, the display of the columnar equipment list can be manipulated by the user by sorting and arranging the columns, or by performing a filtering query using the query function.

As seen in the column headings of the data query pane 122, each piece of equipment includes various detailed information, including “serial number” (i.e., a unique number identifying that specific piece of equipment), “equipment type” (i.e., a general description of the type of equipment), and other identifying information. As seen in the data entry pane 124, the “serial number,” “equipment type” and “condition” (i.e., an indication of whether the equipment is operational, undergoing maintenance, or the like) are required by the CAD system and those data field labels are indicated in bold.

As seen in the data query pane 122, a column labeled “Is Active” provides a checkbox associated with the respective equipment record. The checkbox can be used to easily indicate when any equipment is taken out of service for any reason. For example, if an oxygen tank is damaged or misplaced, a user can immediately mark that equipment as “inactive” so that the CAD system will not attempt to allocate that equipment.

As can be seen in FIG. 5, emergency services equipment is generally grouped by equipment type (e.g., “helicopter” or “fixed wing” are types of vehicles), with specific equipment within that broad type identified by a unique serial number. For example, as shown in the data query pane 122, the broad “Helicopter” equipment type includes four unique specific helicopters having serial numbers of Helicopter-I, Helicopter-II, Helicopter-III, and Helicopter-IV. Similarly, other types of equipment, such as Bassinet, Fixed Wing, Oxygen Tank, and Stretcher, each include several specific pieces of equipment having a unique serial number. As will be discussed in more detail below with respect to the dynamic rostering aspect of the invention, the categorization of equipment by type, and specific equipment within that type, allows the CAD system to dynamically roster that equipment. That is, types of equipment can be allocated to service an emergency event, with the specific equipment of that type being dynamically assigned at the time of dispatch. This enables a system operator to pre-plan a transfer event and then associate the resources at the time of dispatch.

As seen in the data input pane 124 shown in FIG. 5, and in a manner similar to that previously described for FIG. 4, additional equipment can be added by clicking the “+” icon, entering the information for that equipment, and clicking the floppy disk save icon to cause the CAD system to access the database and store the data record for that equipment. In addition, each piece of equipment can have an associated “geofence.” As will be discussed in more detail below, a geofence defines a perimeter around a geographical area. Associating a geofence with a piece of equipment restricts that equipment to operation within the geographical area defined by that geofence. Thus, for example, a piece of equipment having a geofence defining the United States cannot be dispatched for use outside of the United States. Optional information that may be entered for that equipment includes any “affiliate” associations, “brand,” “model,” “purchase date,” and other detailed information shown in that pane.

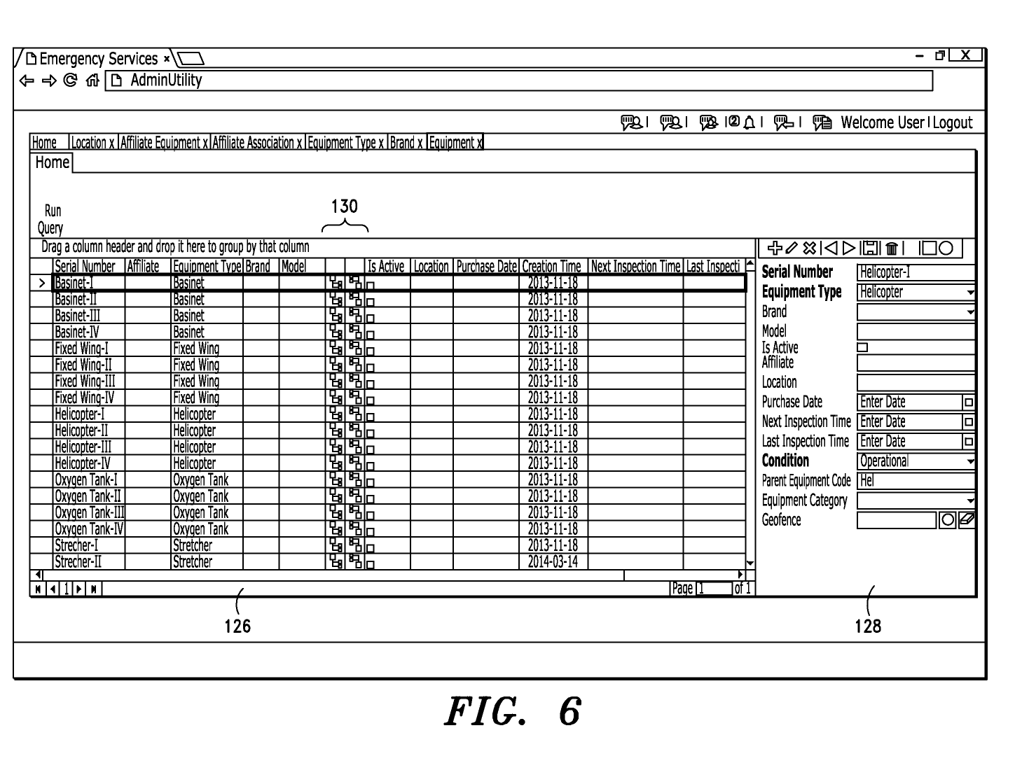

FIG. 6 depicts an exemplary screen shot of a web page showing information for a bassinet piece of equipment. The display and input of information for the bassinet equipment on that web page is similar to that of the helicopter equipment described with reference to FIG. 5. As can be seen, the web page includes a data query pane 126 and a data input pane 128. The data query pane 126 includes two columns having hierarchy tree icons 130. The hierarchy tree view allows a user to see associations or affiliations between pieces of equipment. Clicking on the first icon displays a tree showing any sub-equipment associated with the current piece of equipment, and clicking on the second icon displays a tree showing any equipment to which the current piece of equipment is associated.

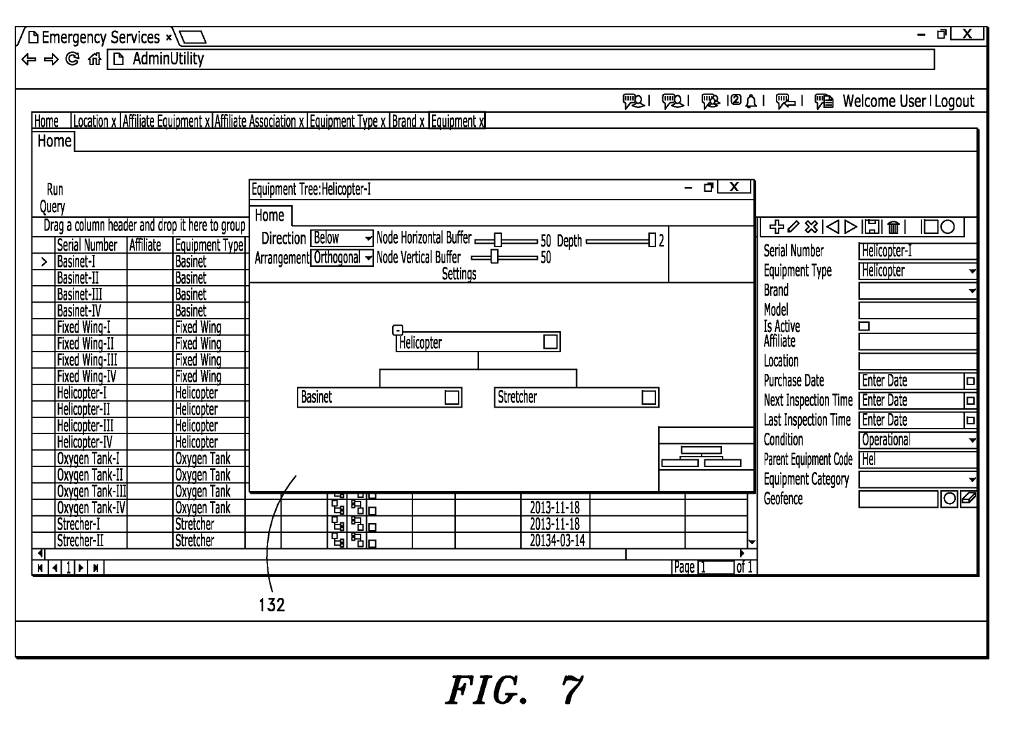

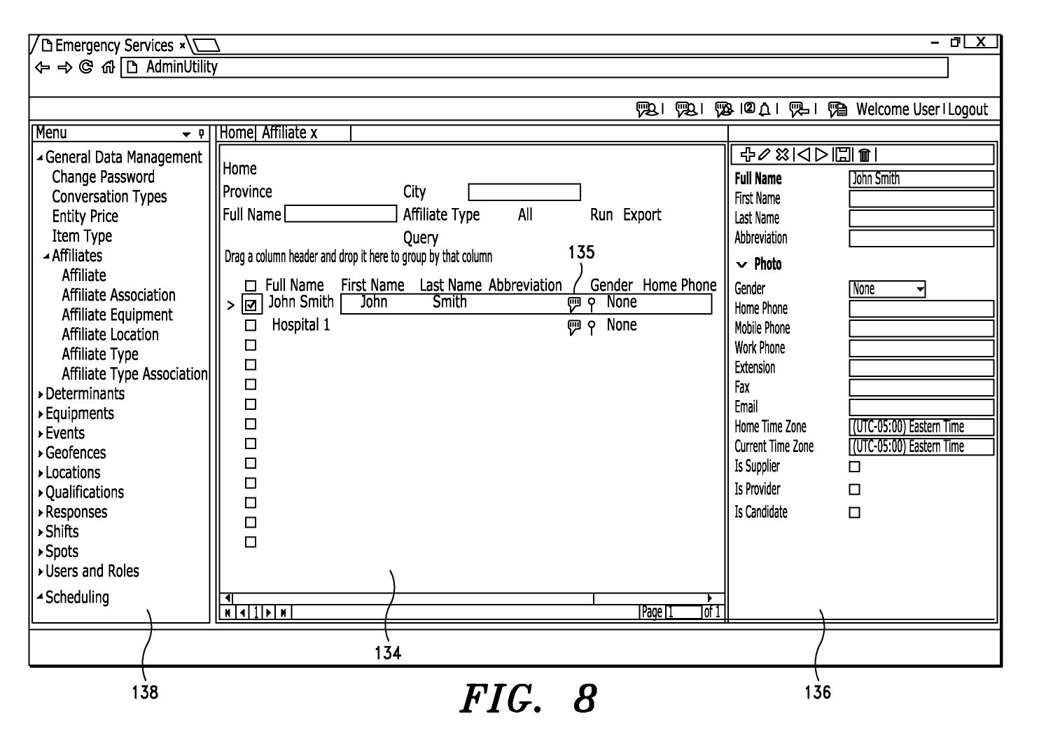

Thus, for example, with the Helicopter-I equipment selected in the data query pane 122 of the web page of FIG. 5, clicking on the first icon causes the CAD system to access the database and retrieve any equipment associated with that helicopter, as depicted in the screen shot of FIG. 7. As seen in FIG. 7, the tree display 132 shows that the helicopter equipment type has associated with it basinet and stretcher equipment types. Thus, when a dispatcher requests or assigns a helicopter, the basinet and stretcher equipment types are requested and assigned along with that helicopter. Thus, the dispatcher does not need to individually request and assign each type of equipment for each dispatching event.

As discussed above, affiliates are people or entities. Affiliates are entered into the CAD system in a manner similar to the facility/locations, vehicles, and other equipment just discussed. In particular, a system administrator sets up affiliates by navigating to an “Affiliate” page as depicted in the exemplary screen shot of FIG. 8. Similar to the other web pages, the web page for entering affiliate information includes a data query pane 134 and a data input pane 136. The operation of those panes in displaying and entering data is exactly as described with respect to the web pages of FIGS. 6 and 7. In the view shown in FIG. 8, the web page also displays a navigation pane 138 which, as previously discussed, may be collapsed by the user if desired. In that case, the web page of FIG. 8 would have an appearance similar to the web pages depicted in FIGS. 6 and 7.

As seen in the data input pane 136, information required by the CAD system for an affiliate is a “Full Name,” a “Home Time Zone,” and a “Current Time Zone,” as indicated by the bold field labels in that pane. The home time zone and current time zone allow the CAD system to determine the availability of an affiliate and to ensure that the time stamp associated with any data records associated with that affiliate reflects that affiliate's correct time zone. Using the “+” icon in the data input pane 136, a user can add new information in a manner as previously described, and then click the floppy disk icon to save that record whereby the CAD system accesses the database and stores the entered information in a new record.

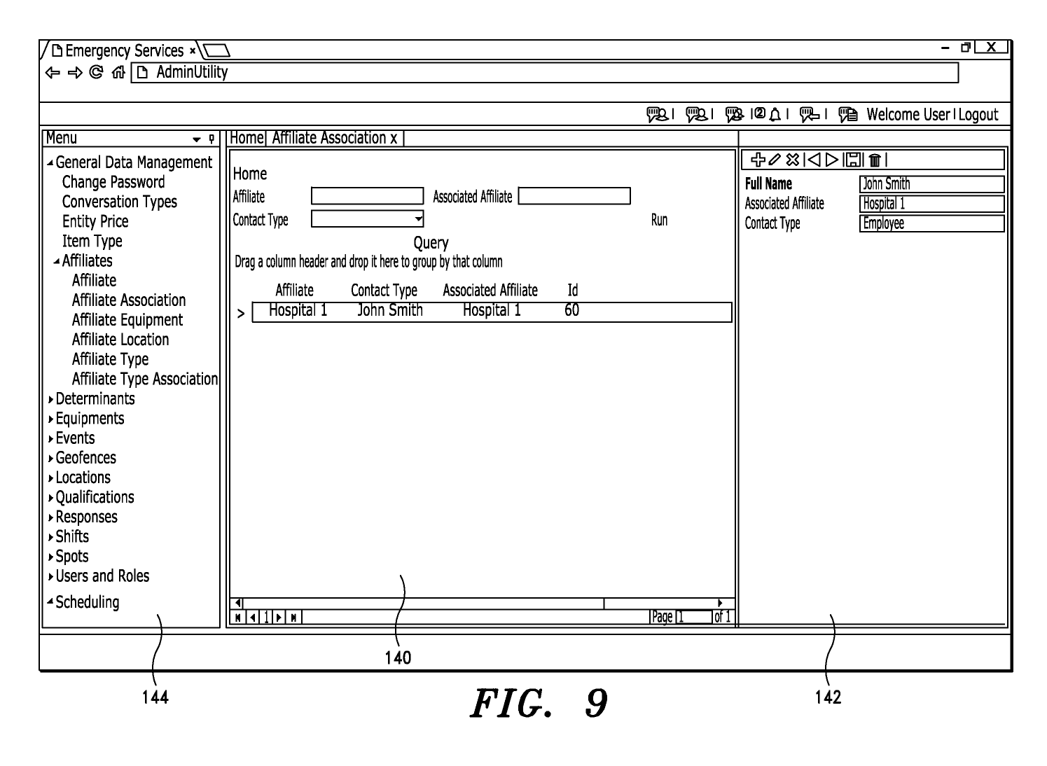

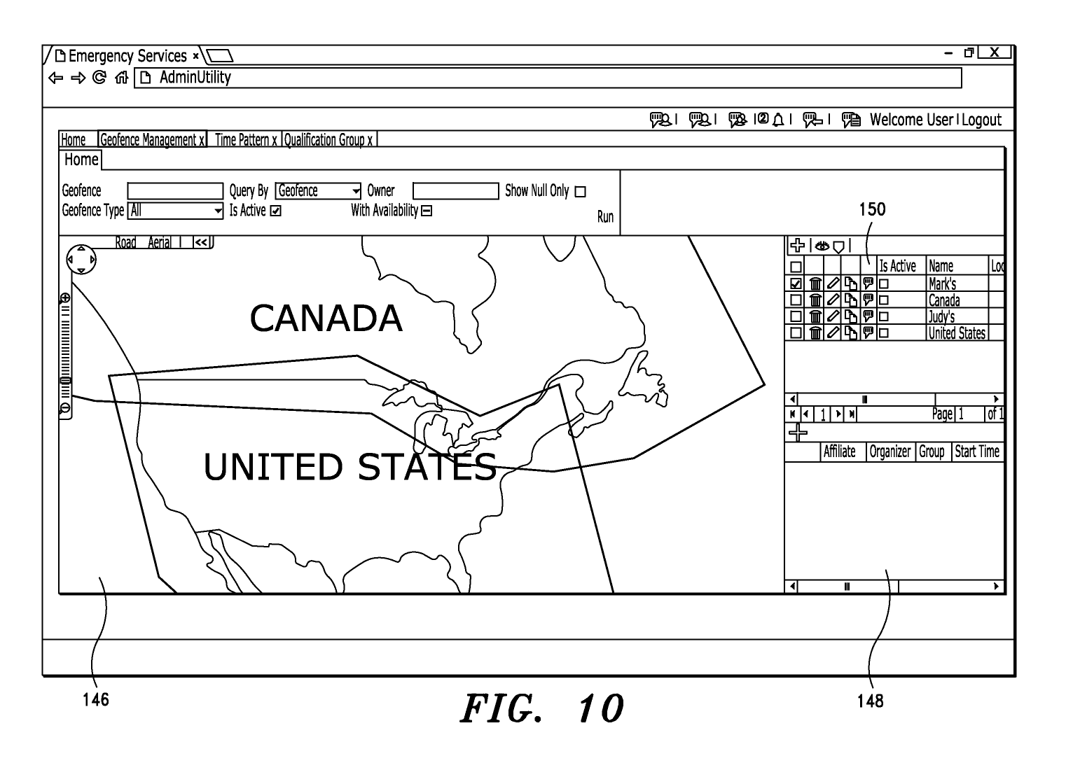

As discussed above, the CAD system enables a user to establish associations between affiliates. Turning to the exemplary screen shot of FIG. 9, it can be seen that the web page includes a data query pane 140 and a data input pane 142, along with a navigation pane 144. The data query pane 140 and data input pane 142 operate in a similar manner to the other web pages described above. Using the “+” icon in the data input pane 142, a user can enter a new affiliate association by selecting an existing affiliate using the “Full Name” dropdown menu, selecting an “Associated Affiliate” from the dropdown menu, and selecting a “Contact Type” from the dropdown menu. It should be understood that the “Full Name” and “Associated Affiliate” drop down menus will be populated with the existing affiliates, i.e., this web page is used to set up an association between existing affiliates. It should also be understood that any given affiliate may be associated with any number of other affiliates. For example, a given hospital affiliate may be associated with multiple doctor affiliates and, likewise, a given doctor affiliate may be associated with multiple clinic affiliates. With the desired affiliate association defined, the user clicks the floppy disk icon to save that record whereby the CAD system accesses the database and stores the entered information in a new record.

Thus, with the emergency services resources defined and setup as described above—including affiliates (i.e., people and, entities), facilities/locations, vehicles, and equipment—those resources are available in the database for access by all users of the CAD system, unless access is restricted by a user's particular role as discussed above.

In a preferred aspect, each of the emergency services resources may include one or more restrictions on its availability, such as a geofence restriction, a time pattern restriction, or a qualification restriction (as well as the “is available” qualification discussed above). A geofence is a user-defined geographical boundary in which a resource is allowed to operate. A time pattern is a user-defined time schedule during which a resource is allowed to operate. A qualification is a user-defined set of criteria associated with a resource that establishes when the use of the resource is appropriate. The CAD system uses the geofence, time pattern, and qualification restrictions to identify where, when, and in what situations a resource can properly be allocated. Preferably, the CAD system only presents to a dispatcher or other user those resources which are available and appropriate for the situation.

Setup Geofences

The CAD system allows users to define one or more geo-fences, i.e., a user-defined geographical boundary in which a resource is allowed to operate. When associated with a resource, a geofence establishes a restriction on the operation of that resource. For example, if a geofence encompassing the United States is associated with a resource, the CAD system would restrict that resource from being assigned or dispatched to a location outside of the United States. Users may define multiple geofences, and may associate more than one geofence with a particular resource. Thus, different geofences, e.g., a geofence encompassing the United States and a geofence encompassing Canada, may be defined by a user. Combinations of those geofences may be associated with various resources. These geofences may be created as required and removed or disabled as needed.

In another example, a fixed wing aircraft vehicle may be associated with both the United States and Canada geofences, while a helicopter vehicle may be associated only with the United States geofence. In that case, the CAD system would not allow the helicopter vehicle to be assigned or dispatched to a situation located in Canada. Most preferably, the CAD system does not even present resources to a dispatcher or other user which are not available for assignment or dispatch in a particular situation.

Geofences may be very broad, encompassing an entire city, county, or country, or may be fairly narrow, encompassing a particular park, fairground, or festival ground. Geofences may similarly be defined to establish a perimeter around a facility/location resource, such as a hospital facility to allow the CAD system to determine when a user is within that perimeter and can be considered to be at that facility/location.

User-defined geofences provide flexibility in assigning and tracking emergency services resources. For example, an emergency services company may define a geo-fence encompassing only the city in which it is licensed to operate. In dispatching resources, the CAD system will not allow assignment of that company's personnel, equipment, or other resources outside of that geofence.

Geofences may also be defined with a user-specified expiration date and time. For example, an emergency services company may be hired to provide coverage at a weekend festival taking place at a fairground. In that case, a user may define a geofence to encompass just that fairground and may set that geofence to expire at the end of the weekend. Upon expiration, that geofence restriction is no longer associated with that company.

Referring now to FIG. 10, a user manages geofences by first navigating to a “Geofence Management” web page. In a manner similar to the web pages discussed above, the “Geofence Management” web page presents a data query pane 146 at the left hand side of the page and a data input pane 148 at the right hand side of the page. The data query pane 146 displays any existing geofences in accordance with the query parameters, which allows a user to search for geofences having a specific name or owner or for geofences that are currently active or of a specific type.

The data input pane 148 allows a user to add, delete, and edit geofences using the “+”, trash can, and pencil icons, respectively. Users can also copy an existing geofence (e.g., to create a new, but similar geofence) using the duplicate/clipboard icon, and can add a comment or information to be associated with the geofence by clicking on the conversation icon as shown in column 150.

To add a new geofence, a user clicks the “+” icon which causes the CAD system to present the web page of FIG. 11. As depicted in FIG. 11, the “Add Geofence” web page presents an editing pane 152 having data input boxes along the left hand side for “Name” (i.e., the name of the new geofence being created), “Owner” (i.e., the user-defined owner of the geofence), and “Location” (i.e., a location for the geofence). The editing pane 152 also presents drop-down menus for the user to select a “Group” and “Type” with which the geofence will be associated. The “group” and “type” selections are user-defined parameters that allow user organization of the geofences. As can in FIG. 11, only the “Name” label is bolded, indicating that the name is the only parameter required by the CAD system.

With the geofence named and other optional data entered into the data input fields, a user defines a geofence by pointing and clicking on the map displayed on the web page. As described previously, the map display can be zoomed and moved by the user to obtain the desired view, and then the user points and clicks on the map to define a perimeter of the geofence. As depicted in FIG. 11, a perimeter has been defined by a user clicking at points 154a, 154b, 154c, 154d, 155e, 155f, and 155g. With the perimeter thus defined, a user can further manipulate the perimeter by clicking and dragging on points 154a-154g, as is known in the art. A user saves the defined geofence by clicking the checkmark icon 156 in the lower left hand portion of the pane, or can cancel the operation by clicking on the “X” icon 158. Clicking the checkmark causes the CAD system to access the database and store the defined goefence in a new record.

As described above, the map display and point selection capability is provided by a mapping service, such as Google Maps or Bing Maps. The geographic coordinates of selected points are provide to the CAD system by the mapping service, whereby the CAD system stores the geographic coordinates of the points defining the perimeter of the geofence in the database. When existing geofences are displayed, for example as shown in the web page of FIG. 10, the CAD system retrieves the coordinates of the points defining the perimeter of the existing geofence from the database and then provides those coordinates to the mapping service to thereby display the existing geofence. Also, in determining whether a particular emergency services resource is located inside or outside of a geofence perimeter, the CAD system retrieves the geofence coordinates from the database and then calculates whether the coordinates of the resource fall within the perimeter defined by the geofence coordinates.

As discussed above, the access devices used by the users of the CAD system preferably include geolocation capabilities, such as the GPS chips contained in most mobile phones, tablets, and smart devices and the geolocation capabilities of Internet-connected devices. The CAD system captures the location data provided by the access device (i.e., latitude and longitude) and uses that information to locate the access device (and thus the user of that device) on the mapping displays in a manner similar to that described with respect to displaying geofences. The mapping services employed by the CAD system permit the display of multiple locations on a map display presented to the user. The CAD system preferably stores that location data in the database in conjunction with any record or event generated by the access devices, along with time stamp information associated with that record or event.

Setup Time Patterns

The CAD system allows users to define one or more time patterns, i.e., a user-defined time schedule during which a resource is allowed to operate. When associated with an emergency services resource, the time pattern establishes a restriction on the times in which that resource is available. A common time pattern is one associated with an affiliate (i.e., a person) who has a defined work schedule or shift. However, time patterns may also be associated with other resources to restrict their availability. For example, an aircraft vehicle may have scheduled maintenance and will be out of service at a particular time, and a time pattern accounting for that restriction can be defined so that the CAD system cannot assign or dispatch that vehicle during that maintenance time. This enables the CAD system to service multiple agencies, each of which may have a different schedule for both personnel and equipment. Thus, any time pattern (no matter how unusual) is user-definable.

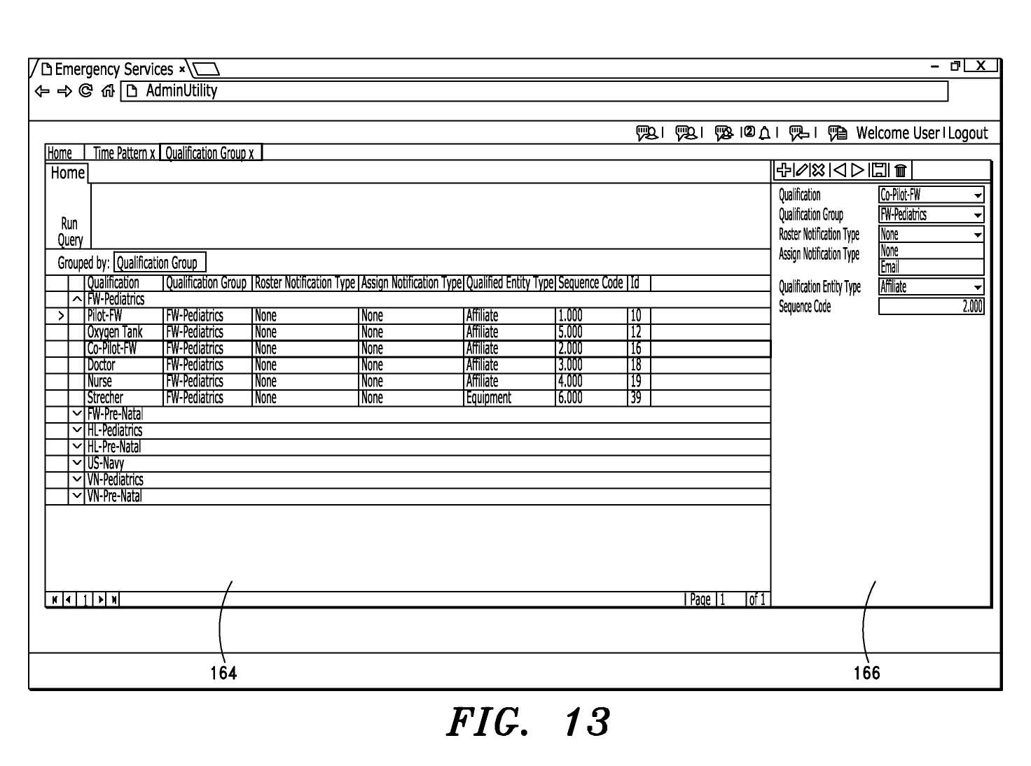

Referring to the exemplary web page of FIG. 12, a user manages time patterns by navigating to the “Time Pattern” web page. The “Time Pattern” web page presents a data query pane 160 at the left hand side of the page and a data input pane 162 at the right hand side of the page. The data query pane 160 displays any existing time patterns in accordance with the query parameters, which allow a user to search for time patterns associated with a particular “Affiliate,” “Country,” “Province,” or “Shift” in a manner similar to that described above. As can be seen, time patterns are defined by a “start time” and an “end time,” a selection of days of the week (i.e., Monday through Sunday), and an “effective time.”

The data input pane 162 allows a user to add, delete, and edit time patterns. To add a new time pattern, a user clicks the “+” icon and enters the data into the data input fields. As indicated by the bold data field labels, the information required by the CAD system for the time pattern is a “start time,” an “end time,” an “effective time” (i.e., when the time pattern becomes effective), and a “country.” Optional information which may be entered by the user includes days of the week, an “expiry time,” a “reason” (i.e., a user-definable reason for establishing the time pattern) and other optional information as shown in FIG. 12. An “Affiliate” drop down menu in the data input pane 162 allows the user to associate the time pattern with an affiliate (i.e., a person or entity). Thus, the CAD system will apply the selected time pattern restrictions to that affiliate and any resources associated with that affiliate. A common circumstance in which a user applies a time pattern restriction is in establishing work shifts for a person affiliate (e.g., a paramedic), in which case a shift might be set up as 8 a.m. to 6 p.m. Monday through Friday. With the time pattern defined, a user clicks the floppy disk icon which causes the CAD system to access the database and store the defined time pattern restriction as part of the record for the person affiliate.

Setup Qualifications

The CAD system also allows users to define one or more qualification groups, i.e., a user-defined set of criteria associated with a resource that establishes when the use of the resource is appropriate. In this regard, a user may define a group (e.g., a pediatrics or prenatal group) and any resources to be used in association with the group must meet certain criteria. For example, in establishing a pediatric group qualification, a user would need to have doctors, nurses, equipment and other resources that meet the user's criteria for that group. That is, the doctors and nurses must have the appropriate qualifications to treat pediatric patients and the equipment must be qualified for use with pediatric patients (e.g., must be the correct size, dosage, etc. for use with pediatric patients). The CAD system tracks the qualifications associated with each resource and allocates a resource only if the resource is qualified for the event being scheduled or dispatched. Further, qualifications can be associated with time patterns to ensure that no unqualified personnel respond on the road (e.g., a paramedic did not renew his license or did not pass a recertification).

For example, if the CAD system has two affiliate doctors stored in the database and only one of those doctors is qualified to treat pediatric patients, the CAD system will not allocate the non-qualified doctor if the event being scheduled by the dispatcher requires a pediatric qualification. However, if the event being scheduled has no qualifications, then the CAD system would present both doctors as being available for the response (assuming no other restrictions apply). Thus, the qualification assures that only resources meeting specific criteria are allocated to a particular response.

Turning to FIG. 13, a screen shot of an exemplary web page for assigning qualifications is depicted. The “Qualification Group” web page presents a data query pane 164 at the left hand side of the page with a data input pane 166 at the right hand side of the page. The data input pane 166 allows a user to add, delete, and edit qualification groups. To add a new qualification group, a user clicks the “+” icon and enters the data into the data input fields in the data input pane 166. Thus, for example, as shown in the data query pane 164, a fixed wing pediatrics group “FW—Pediatrics” can be defined by a user to require a fixed wing pilot “Pilot—FW,” an “Oxygen Tank,” a “Co-Pilot FW,” a “Doctor,” a “Nurse,” and a “Stretcher.” As can be seen in the data query pane 164, other similar qualification groups can be defined, such as “Pre-Natal.” With a qualification group defined, a user clicks the floppy disk icon which causes the CAD system to access the database and store the defined qualifications in a new record.

Communications

In addition to dispatching and tracking emergency services resources (described below), the CAD system includes an integrated communications backbone that allows users to enter notes and comments associated with an event, to upload photos, documents, or other information associated with an event, and to communicate with other users of the CAD system. All such communications are collectively referred to as “conversations” and all such conversations are stored in association with an event or events in the database, along with time-stamp and geolocation information where applicable. For example, a mobile user, such as a paramedic, may enter a comment regarding the condition of a patient being transported, or upload a picture or document relating to that patient. The CAD system stores that conversation along with timestamp and geolocation information in association with that transport event by accessing the database and storing a record containing such information.

The conversation feature is available from most of the web pages presented by the CAD system, either in the form of a conversation ribbon appearing at the top of the page or with specific conversation icons placed elsewhere on a page, e.g., in proximity to a listing of scheduled transfer events where users may often want to enter comments having relevant information relating to the transfer event. For example, referring to FIG. 8, a conversation icon column 135 allows a user to click the icon for a particular record whereby a conversation pop-up box is presented to the user to allow the entry of text comments, or the attachment of photos, images, etc. The entered information is then stored in the database in association with that record.

The CAD system also allows notifications to be sent to specific users or groups of users to notify of system events, such as a change to an assignment for a particular user or a cancellation of an event to the group of users scheduled for that event. Most communication occurs directly as messaging through the CAD system. However, because the CAD system is web-based, it also provides for outgoing communication via email so that a user can be notified even when they are not currently logged-in to the CAD system (e.g., an off-duty user could be notified via email regarding a change in a scheduled event). All communication data is time-stamped, logged and stored in the database in association with the appropriate event.

Dynamic Rostering

With the database of the CAD system populated with information defining the emergency services resources available to be dispatched (e.g., affiliates, vehicles, and equipment) and with any restrictions relating to those resources defined (e.g., geofences, time patterns, and qualifications), the operation of the CAD system in dispatching those resources will now be described.

Unlike conventional CAD systems that typically schedule and assign specific resources ahead of time and/or by shifts (e.g., from 8 to 5 today, this specific ambulance with this specific crew will be on call), the CAD system of the present invention permits “dynamic rostering.” That is, while types of resources may be scheduled ahead of time, specific equipment is rostered (i.e., assigned) dynamically, on-the-fly, in real time.

Dynamic rostering involves a dispatcher first specifying the types of resources required for a particular emergency response by creating a virtual “unit” comprising the required resources for that emergency response. Only at the time of dispatch does the CAD system assign the specific resources required to fill that unit (i.e., dynamically “rostering” the unit) based on the availability of the specific resources. The CAD system determines the availability of a specific resource based on any restrictions associated with that resource, namely, geofences, time patterns, qualifications, and any availability restrictions as discussed above.

For example, if the type of vehicle required for an emergency response is a fixed wing aircraft, and a specific fixed wing aircraft is designated in the database as being “inactive” (see discussion of “inactive” status with respect to FIG. 6 above), the CAD system will not allow a dispatcher to assign that specific aircraft to the unit created for the emergency response. In fact, the CAD system will not even present that specific aircraft on a list of aircraft for the dispatcher to choose from in rostering that unit. As another example, a specific ambulance may have a license to operate only within city limits, with an associated geofence defining those city limits. In that case, the CAD system would not present that specific ambulance on a list of ambulances for the dispatcher to choose from in rostering a response unit for an accident outside of those city limits.

The CAD system likewise ascertains the availability of specific resources based on time pattern and qualification restrictions associated with that resource. For example, a paramedic affiliate on call from 8 a.m. to 7 p.m. may have a corresponding time pattern associated with her record in the database. In that case, the CAD system would not offer that paramedic as a choice to a dispatcher needing to assign a paramedic to a unit for dispatch at 10 p.m. Similarly, in the case of an emergency situation requiring a pediatric specialty response, the CAD system would only make available to the dispatcher those resources that are associated with the required pediatric qualification for assignment to the unit being dispatched.

Thus, the CAD system provides dynamic rostering that allows real-time allocation of specific resources based on real-time information and restrictions associated with those resources as stored in the database and retrieved from the database at the time of rostering.

Scheduled Dispatch

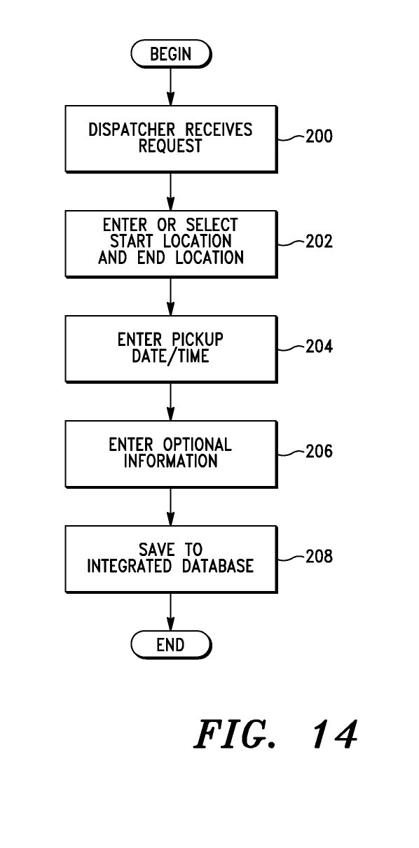

An exemplary method of performing a scheduled dispatch of emergency services using the CAD system, i.e., ordering a scheduled dispatch of emergency services, creating a unit to provide those services and dynamically rostering that unit, will now be described with reference to the exemplary flow diagrams and exemplary screen shots depicted in FIGS. 14-23.

A scheduled dispatch is one of the most common dispatching situations encountered by many emergency service providers, and typically involves the transfer of a patient between medical facilities via land or air vehicles. For example, a patient at a trauma hospital may be transferred to a different facility once they have begun recovery, or a patient may be transferred between hospitals in order to access specialized equipment at another facility. While these scheduled transfers are not necessarily emergency situations in the same sense as injury traffic accidents, the patients still require emergency services resources to facilitate the transfer. Because these situations are not time-critical emergency situations, the transfers can be, and typically are, scheduled ahead of time.

Looking first to FIG. 14, a flow diagram of an exemplary method of ordering a scheduled dispatch of emergency services resources in accordance with the present invention is presented. At block 200, a dispatcher receives a request or order to schedule a transfer, e.g., a patient may need to be transferred between two hospital facilities on a specific day at a specific time. At block 202, the dispatcher accesses the CAD system to book the order. In particular, the CAD system accesses the database and retrieves data for all existing facilities/locations and displays them to the dispatcher. The dispatcher selects a start location and an end location for the transfer from those presented by the CAD system. If either of the facilities required for the transfer are not already in the database, the dispatcher can enter the name of the facility and location or select the location on the map display as previously described, whereby the new facility/location is stored in the database.

With the start location and the end location selected, at block 204, the dispatcher enters the pickup time, i.e., the date and time that the patient will be picked up from the start location. The start location, end location, and pickup date and time are the only information required by the CAD system to schedule the transfer event. However, at block 206, the dispatcher can enter additional optional information relating to the transfer, such as the patient's name, or any other information relating to the transfer event. At block 218, the dispatcher confirms the transfer order whereby the CAD system stores the transfer order in the database.

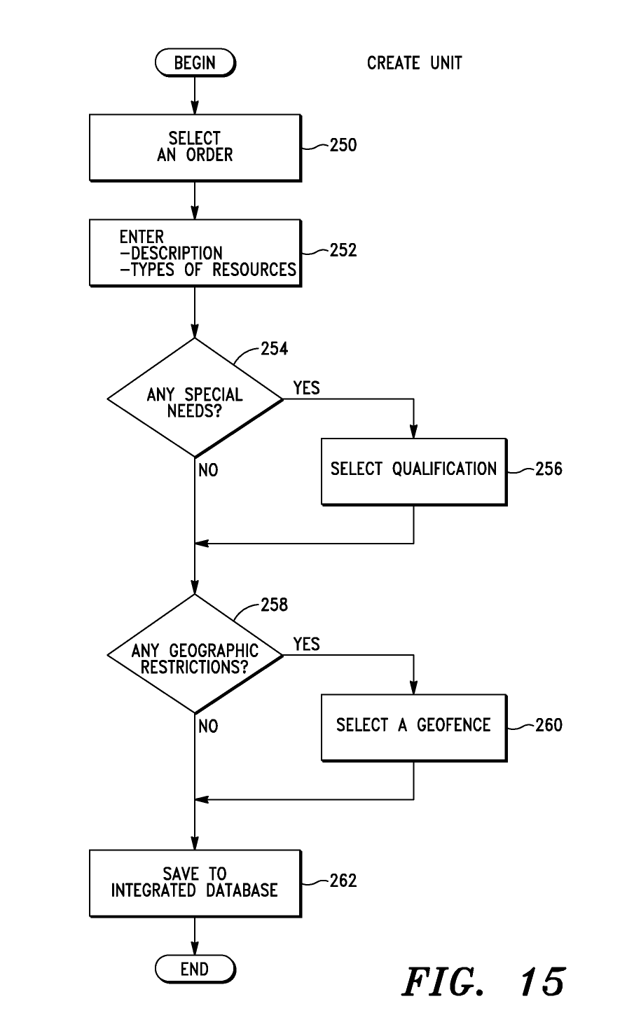

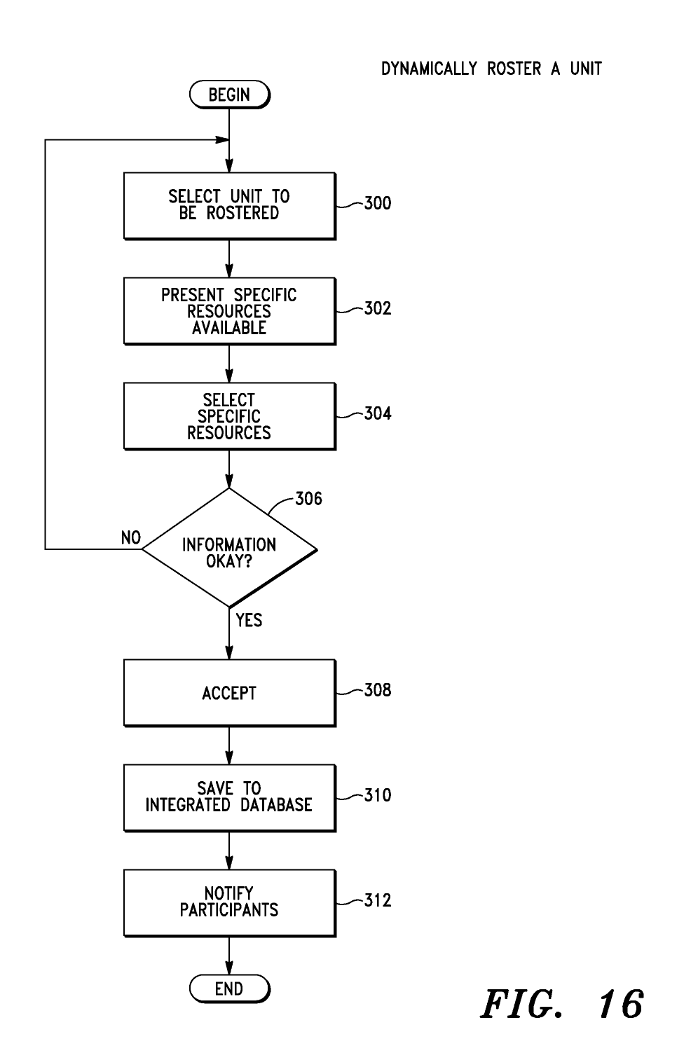

Turning to FIG. 15, with the transfer order created as just described, a flow diagram of an exemplary method of creating a unit to fulfill the transfer order in accordance with the present invention is presented. At block 250, the dispatcher selects an order from a list of orders retrieved from the database and presented by the CAD system. At block 252, the dispatcher enters a description (i.e., name) for the unit and selects the types of resources (e.g., personnel, vehicle, equipment and other resources) required to effect the transfer from a list of resource types retrieved from the database and presented by the CAD system. At block 254, it is determined if the transfer order has any special requirements, such as a requirement of pediatrics or cardio specialties. If so, at block 256, the dispatcher selects any necessary qualifications from the qualifications list presented by the CAD system. At block 258, it is determined if any geographic restrictions are to be applied to the unit. If so, at block 260, the dispatcher selects a geofence to apply to the unit from a list of geofences retrieved from the database and presented by the CAD system, or the dispatcher may create a new geofence if an appropriate one does not exist. At block 262, with the unit created, the CAD system stores the created unit in the database.

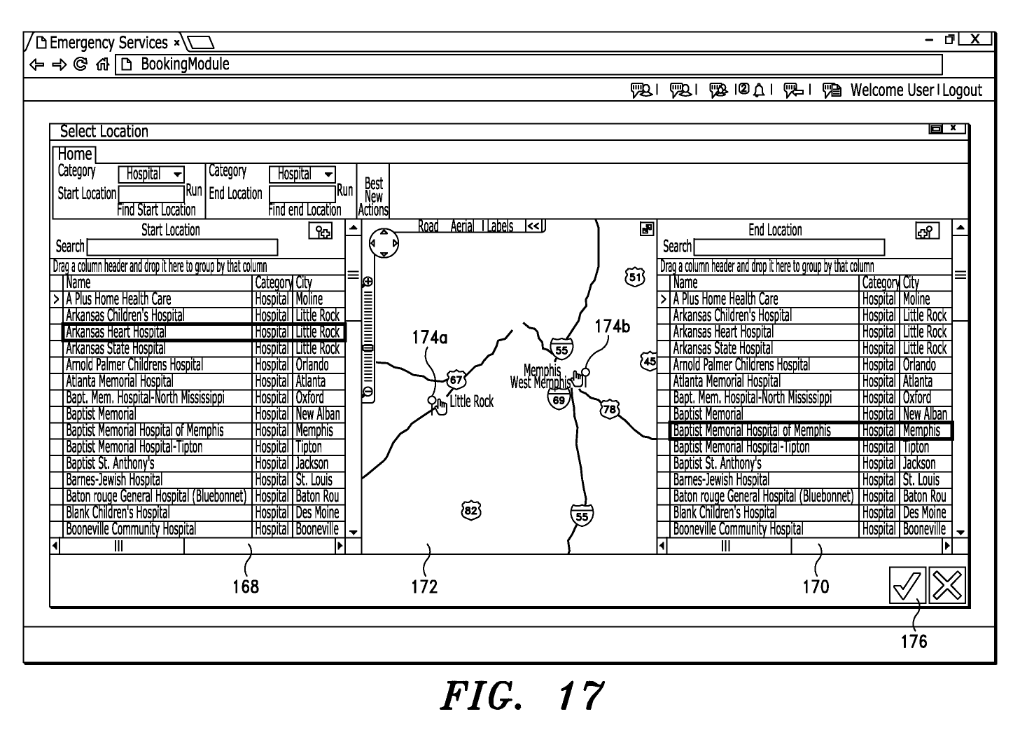

Turning to FIG. 16, with a unit created as just described, a flow diagram of an exemplary method of dynamically rostering a unit in accordance with the present invention is presented. As described above, dynamic rostering is the assignment of specific resources to a virtual unit. Thus, dynamic rostering typically occurs closely in time to the start time of the event. At block 300, a dispatcher selects a unit to be rostered from the list of units retrieved from the database and presented by the CAD system. At block 302, for each type of resource (e.g., personnel, vehicle, equipment and other resources), the CAD system retrieves from the database and presents to the dispatcher a list of specific resources available to fill the selected unit. In compiling the list of available resources, the CAD system takes into account any restrictions associated with the resources, i.e., the availability of the resources, any geofences associated with the resources, any time patterns associated with the resources, and any qualifications associated with the resources, and presents only those resources that meet all of those restrictions. At block 304, for each resource type, the dispatcher selects the specific resources for the unit from the list presented by the CAD system.

At block 306, the dispatcher determines if the selected resources are correct. If so, at block 308, the CAD system categorizes the resources as rostered to the unit and, at block 310, the CAD system stores the information in the database. If, at block 306, the dispatcher does not accept the resources, the process is repeated (or the dispatcher can navigate to any other web page, if necessary). Finally, at block 312, with specific resources assigned, participants in the event are notified by the CAD system using the conversation feature described above.

The exemplary methods described in connection with the flow charts of FIGS. 14-16 will now be described in conjunction with exemplary web pages presented by the CAD system.

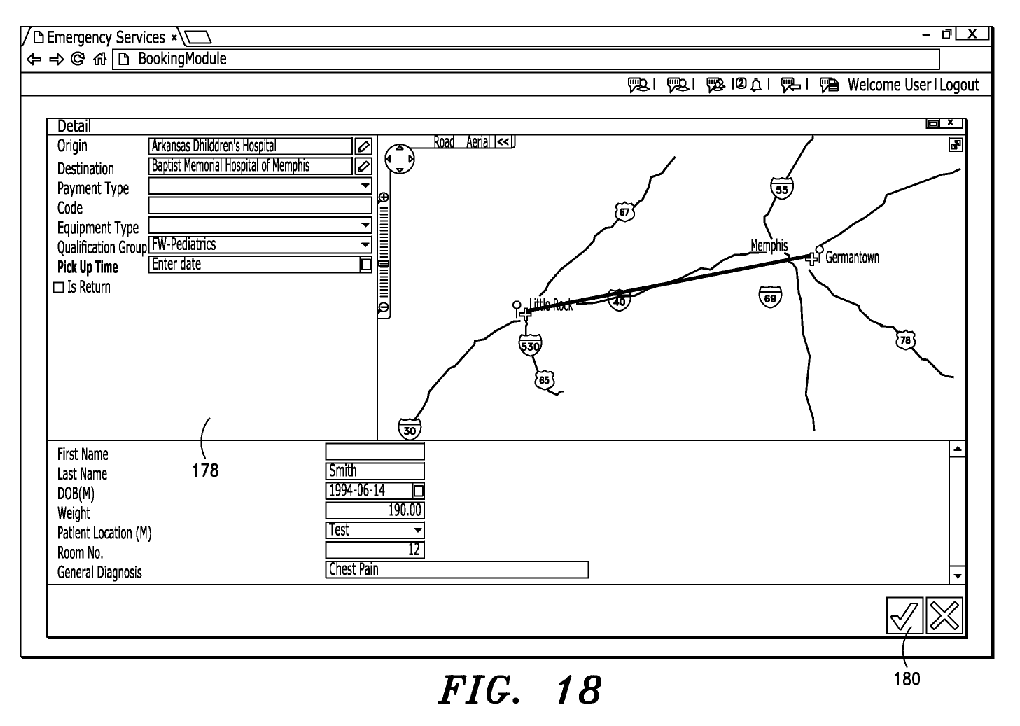

First, a dispatcher navigates to a “Booking Module” web page as depicted in FIG. 17. As can be seen, the CAD system presents a “Start Location” data query pane 168 at the left side of the page and an “End Location” data query pane 170 at the right side of the page, as well as a map display pane 172 in the center of the page. The start and end location panes present lists of existing facility/locations retrieved from the database by the CAD system. As described above, the displayed start and end locations can be filtered using the query controls on the web page.

In this exemplary embodiment, the dispatcher selects Arkansas Heart Hospital as the start location and Baptist Memorial Hospital of Memphis as the end location (i.e., the dispatcher is scheduling the transfer of a patient between those two locations). The CAD system retrieves the geographic coordinates for each location by accessing the database and retrieving the stored geographic coordinates for each location, and provides that information to the mapping service so as to present a map display in the center pane 172. Preferably, the map displays the start and end locations as push pins 174a, 174b on the map. Most preferably, the displayed start and end location push pins are different colors, such as green and red, respectively, to distinguish the two locations.

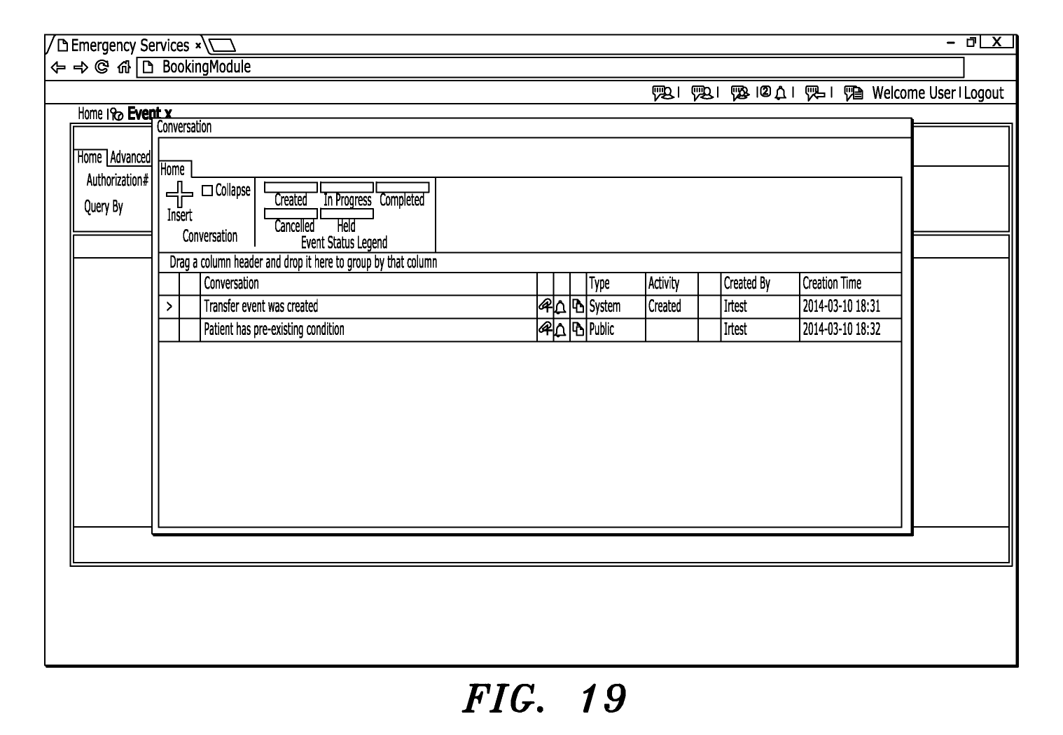

With the start and end locations selected, the dispatcher clicks the check mark 176 at the lower right of the page, which causes the CAD system to display a “Detail” page as depicted in FIG. 18. As seen in FIG. 18, the start and end locations are auto-populated into the left hand data input pane 178e. The dispatcher must then enter a “pick up time”, i.e., the date and time the patient will be picked up from the start location. As described previously, because the “pick up time” label is shown in bold, that data is the only information required by the CAD system.

The dispatcher may then enter optional “payment type” information (i.e., how the service will be paid for), a “code” (i.e., a user-defined code to associate with the event), “equipment type” information (i.e., what type of vehicle is needed for the transfer) and a “qualification group” (i.e., any particular qualification restrictions, in this case helicopter pediatrics “FW Pediatrics” is selected). Additional optional information may be entered in the data input boxes appearing in the data input pane at the bottom of the page, including the patient's first and last names, date of birth, weight, location, room number, and general diagnosis. These optional fields are not required for the dispatch, but are user configurable and may be setup by a system administrator to capture any desired information required by a particular emergency services company operating the CAD system. When the information has been entered, the dispatcher clicks the check box 180 in the lower right hand corner of the page and the CAD system stores the transfer order in the database.

At this point (or any other point during use of the CAD system) the dispatcher may click one of the conversation icons located in the upper right of the page (as described above with respect to FIG. 3), which causes the CAD system to present a conversation page showing any conversations entered and associated with the transfer event. In the example shown in FIG. 19, the user has entered a “Patient has pre-existing condition” comment which appears in the conversation list associated with that event. As discussed above with respect to the conversation feature, that conversation is time stamped and the CAD system stores the record in the database in association with the transfer event.

At this point, the transfer event itself has been scheduled/ordered, with start and end locations selected, but no resources have yet been requested or associated with the event. It should be understood that a unit associated with a transfer event may be (but is not required to be) created well in advance of the ultimate dispatch of that unit. Thus, in the case of prescheduled transfers, it is likely that a unit could be created in advance which specifies the types of resources necessary for the transfer of a patient between two hospital facilities. In that case, the created unit would simply be associated with that transfer event until the start time of the event approaches. At that time, the dispatcher dynamically rosters the previously created unit with specific resources listed by the CAD system as being available at that time. However, in the case of dispatching emergency services to an accident scene (discussed in more detail below), a dispatcher may need to create the unit just before dynamically rostering and dispatching the unit. Rostering the units only at the time they are needed, i.e., dynamic rostering, ensures that the specific resources are actually available to fill that unit and have not been previously assigned.

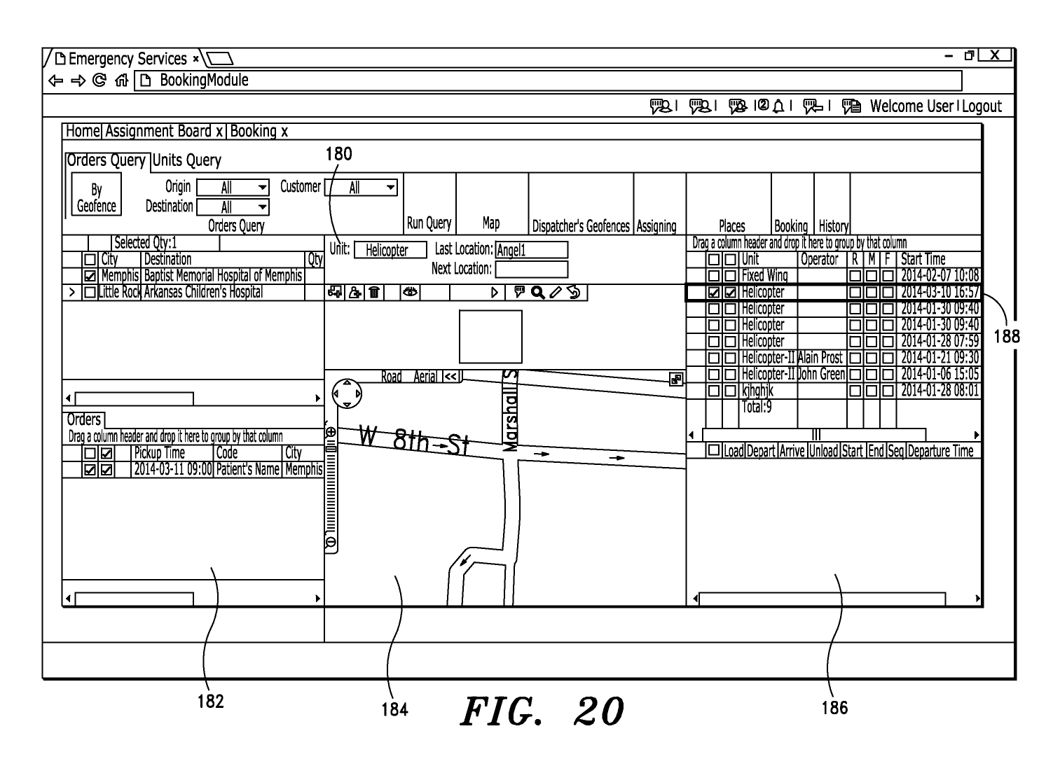

Turning to FIG. 20, with the transfer event scheduled, the dispatcher navigates to an “Assignment Board/Booking” web page to create a unit, i.e., a virtual collection of the types of resources required to accommodate the scheduled transfer event. This web page presents three panes—an order section 182 is displayed in the left-hand pane, a load section 184 is displayed in the middle pane, and a unit section 186 is displayed in the right-hand pane.

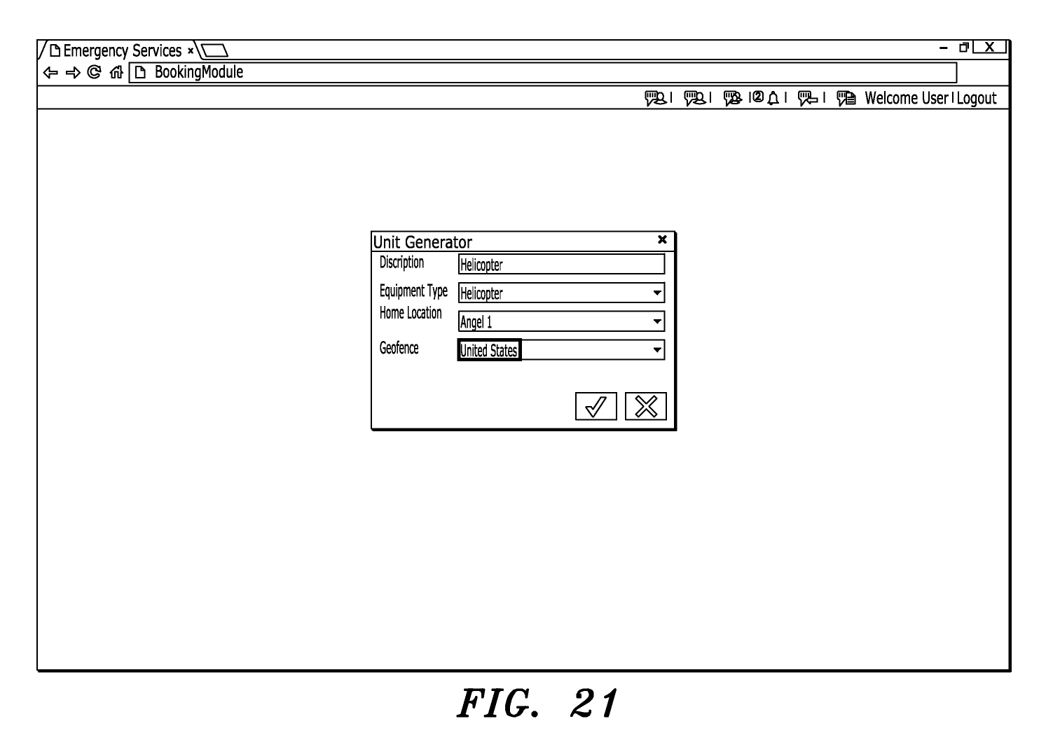

The order section 182 presents a summary of the transfer order created for the transfer event. Clicking on that order causes the CAD system to display the detailed information associated with that order in the lower portion of the order section 182. To create a new unit, the dispatcher clicks on the “unit” button 180 in the load section 184, which causes the CAD system to display the pop-up input box depicted in FIG. 21. In this “Unit Generator” box, the dispatcher enters a “Description” (i.e., a name for the unit), and selects the “Equipment Type” (e.g., helicopter, fixed wing aircraft, ambulance, etc.) and “Home Location” (i.e., the home base for the unit) from drop-down menus. The dispatcher may also assign a geofence to restrict the areas in which the unit may operate, as described above. The created unit 188 then appears in the unit section 186 of the web page.

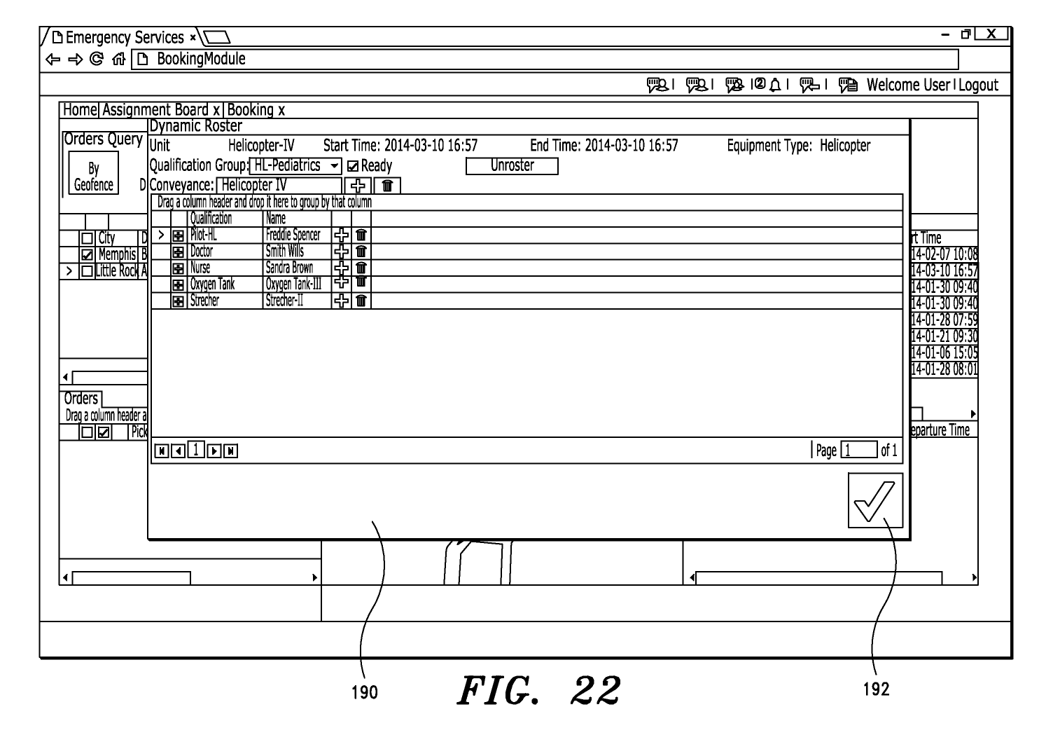

To roster the unit, the dispatcher selects the checkbox in the first column next to the unit name, and selects the checkbox in the roster column “R” for that unit. This causes the CAD system to display the “Dynamic Roster” web page depicted in FIG. 22. On that page, the CAD system displays the specific resources available to fill the unit, which are retrieved from the database based on any restrictions associated with those resources, such as availability status, geofences, time patterns, and qualifications.

In this example, the CAD system displays that helicopter serial number Helicopter-IV is available, and that the specific pilot, doctor, nurse, oxygen tank, and stretcher as indicated in pane 190 are qualified for pediatric response and available to fill the unit. By clicking the checkmark 192 at the lower right hand corner of the web page, the dispatcher accepts the specific resources assigned by the CAD system and the unit has been dynamically rostered with specific resources. The CAD system then stores the assignment/rostering record in the database and the specific equipment assigned to the unit are noted in the database as not being available to allocate to other conflicting events.

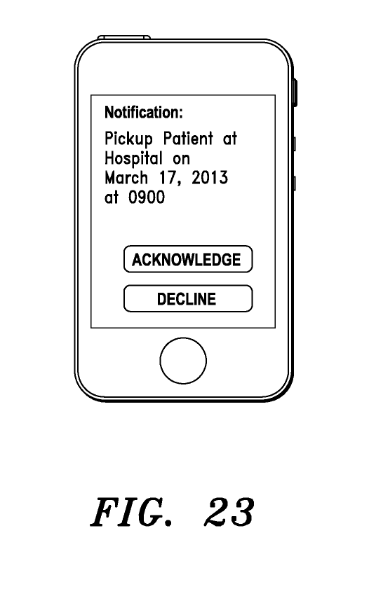

With the specific resources rostered/assigned, the affiliates associated with those resources are notified by the CAD system using the communication features described above. For example, the CAD system sends conversation messages to the specific pilot, doctor, and nurse just rostered, whereby that notification will appear on each user's conversation ribbon when they are logged into the CAD system. The CAD system will also preferably send an alert to the mobile devices of such users, such as the notification depicted in FIG. 23. A user receiving such a notification will preferably acknowledge or decline the assignment. The CAD system receives and records those responses in the database. In the event a user declines (or does not respond to) a notification, the CAD system will alert the dispatcher who may assign another user in accordance with the exemplary steps described above.

At this point, the affiliates and other emergency resources are assigned to handle the emergency event and will depart the start location at approximately the specified start time. The CAD system can monitor and track the location of any resources having GPS information, such as the mobile devices carried by individual affiliates (e.g., an individual paramedic). That GPS coordinate information may be used by the CAD system to display the location on a mapping display in a manner similar to that previously described. Thus, a dispatcher user can view particular dispatched orders and track the progress of the response. When the responders arrive at the end location, ending that particular event, the CAD system may automatically cancel the unit to free-up any assigned resources for additional calls. Alternatively, the unit may be maintained by the CAD system, allowing the dispatcher to quickly dynamically roster that unit again. Thus, in the case of a response to an emergency dispatch (discussed below), the dispatcher may essentially re-roster that unit with the same resources to schedule a second transfer event, e.g., transfer of an accident victim to the hospital. At the end of that second transfer event, the CAD system would again designate those specific resources as available, and record that information in the database. Those specific resources would then be available for subsequent dispatch and assignment.

While an exemplary embodiment of the present invention has been described above in relation to a scheduled dispatch of emergency services, one skilled in the art will understand that the CAD system may also be used to perform an emergency dispatch of emergency services. An emergency dispatch is essentially the same as a scheduled dispatch, with the following differences.

First, the dispatcher will not order dispatch of emergency services and create a unit to provide those services in advance of dynamically rostering that unit. Because the event is an emergency situation, the dispatcher will perform all of these steps at the time of receiving an emergency call. Also, predefined units will be created in advance so that those units are available for a dispatcher to immediately assign upon receipt of an emergency call. Thus, the dispatcher does not have to create a unit each time an emergency call comes in, although she may do so if the call requires uncommon resources.

Second, the dispatcher must screen the call requesting emergency dispatch to ascertain the required emergency services. Typically, a dispatcher will make that determination using a questionnaire that provides a series of questions for the dispatcher to ask the caller, which may be in the form of a book or presented on a computer screen or display.

Third, an emergency dispatch may require two dispatch events, i.e., an initial dispatch event from a start location of a unit to an end location comprising the scene of the accident and a possible second dispatch event from the scene of the accident to a hospital. Because the scene of the accident is not likely to be a location already existing in the database, the dispatcher may enter the address or select the location on the map display of the web page as described above. If an accident victim requires transport to a hospital, the second dispatch event could be scheduled using the CAD system in a manner similar to the initial dispatch event.

While the present invention has been described and illustrated hereinabove with reference to several exemplary embodiments, it should be understood that various modifications could be made to these embodiments without departing from the scope of the invention. Therefore, the present invention is not to be limited to the specific configuration and methodology of the exemplary embodiments, except insofar as such limitations are included in the following claims.

1. A system that enables a user to pre-plan for a transfer event and then dynamically assign emergency services resources to the transfer event at a time of dispatch, comprising:
a plurality of access devices; and
a computer-aided dispatch (CAD) system accessible by the access devices, wherein the CAD system presents a plurality of web pages that enable a plurality of users using the access devices to:
configure a plurality of emergency services resources for storage in a database;
create a plurality of transfer orders each of which defines a plurality of required criteria for a transfer event, wherein the transfer event comprises transfer of a patient from a start location to an end location on a specified date and at a specified time, wherein the required criteria comprises the start location for the transfer event, the end location for the transfer event, and the specified date and time for the transfer event, wherein each created transfer order is stored in the database;
create a virtual unit to fulfill each transfer order, wherein the virtual unit identifies one or more resource types required for the transfer event and does not identify any of the emergency services resources stored in the database, wherein each created virtual unit is stored in the database; and then
roster each virtual unit with one or more of the emergency services resources stored in the database that are associated with the required resource types identified in the virtual unit so as to create a rostered unit for the transfer event, whereby a dispatch notice is sent to at least one of the emergency services resources in the rostered unit.

2. The system of claim 1, wherein each of the access devices runs a web browser application that enables access to the CAD system over the Internet, whereby each of the access devices communicates with the CAD system using the web browser application.

3. The system of claim 1, wherein the users comprise a plurality of dispatchers.

4. The system of claim 1, wherein each of the resource types comprises one of a personnel type, a vehicle type, and an equipment type.

5. The system of claim 1, wherein the virtual unit is created by selecting the one or more resource types required for the transfer event from a list of resource types.

6. The system of claim 5, wherein the resource types on the list are configured by one or more system administrators using one or more of the access devices.

7. The system of claim 1, wherein the virtual unit is rostered by selecting the one or more of the emergency services resources from a list of available emergency services resources.

8. The system of claim 7, wherein the emergency services resources in the rostered unit are assigned on the fly to the transfer event.

9. The system of claim 7, wherein the available emergency services resources on the list do not contain a restriction on availability in relation to the transfer event.

10. The system of claim 9, wherein the restriction on availability comprises one of a geographic restriction, a time restriction, a qualification restriction, and combinations thereof.

11. The system of claim 1, wherein all data used to create the transfer order, create the virtual unit and roster the virtual unit is stored in a single database.

12. A method for dynamic rostering of emergency services resources via remote access to a computer-aided dispatch (CAD) system by a plurality of access devices, comprising:
presenting, by the CAD system, a plurality of web pages that enable configuration by at least one of the access devices of a plurality of emergency services resources;
storing the emergency services resources in a database;
presenting, by the CAD system, a plurality of web pages that enable creation by at least one of the access devices of a plurality of transfer orders each of which defines a plurality of required criteria for a transfer event;
storing each transfer order in the database;
presenting, by the CAD system, a plurality of web pages that enable creation by at least one of the access devices of a virtual unit to fulfill each transfer order, wherein the virtual unit identifies one or more resource types required for the transfer event and does not identify any of the emergency services resources stored in the database;
storing each virtual unit in the database;
presenting, by the CAD system, a plurality of web pages that enable rostering by at least one of the access devices of each virtual unit with one or more of the emergency services resources stored in the database that are associated with the required resource types identified in the virtual unit so as to create a rostered unit for the transfer event;
storing each rostered unit in the database; and
sending, by the CAD system, a dispatch notice to at least one of the emergency services resources in the rostered unit.

13. The method of claim 12, wherein each of the resource types comprises one of a personnel type, a vehicle type, and an equipment type.

14. The method of claim 12, wherein the virtual unit is created by selecting the one or more resource types required for the transfer event from a list of resource types.

15. The method of claim 14, further comprising the step of presenting, by the CAD system, a plurality of web pages that enable configuration of the resource types on the list.

16. The method of claim 12, wherein the virtual unit is rostered by selecting the one or more of the emergency services resources from a list of available emergency services resources.

17. The method of claim 16, wherein the emergency services resources in the rostered unit are assigned on the fly to the transfer event.

18. The method of claim 16, wherein the available emergency services resources on the list do not contain a restriction on availability in relation to the transfer event.

19. The method of claim 18, wherein the restriction on availability comprises one of a geographic restriction, a time restriction, a qualification restriction, and combinations thereof.

20. The method of claim 12, wherein all data used to create the transfer order, create the virtual unit and roster the virtual unit is stored in a single database.

21. A computer-aided dispatch (CAD) system that enables a user to pre-plan for a transfer event and then dynamically assign emergency services resources to the transfer event at a time of dispatch, comprising
a database server that maintains a single database; and
an application server in communication with the database server; and
a web server in communication with the application server, wherein the web server presents a plurality of web pages that enable a plurality of remote users using a plurality of access devices to:
configure a plurality of emergency services resources for storage in the database;
create a plurality of transfer orders each of which defines a plurality of required criteria for a transfer event, wherein each created transfer order is stored in the database;
create a virtual unit to fulfill each transfer order, wherein the virtual unit identifies one or more resource types required for the transfer event and does not identify any of the emergency services resources stored in the database, wherein each created virtual unit is stored in the database; and then
roster each virtual unit with one or more of the emergency services resources stored in the database that are associated with the required resource types identified in the virtual unit so as to create a rostered unit for the transfer event, whereby a dispatch notice is sent to at least one of the emergency services resources in the rostered unit.

22. The CAD system of claim 21, wherein each of the remote users accesses the web pages using an access device running a web browser application that enables access to the web server over the Internet, whereby each of the access devices communicates with the web server using the web browser application.

23. The CAD system of claim 21, wherein the remote users comprise a plurality of dispatchers.

24. The CAD system of claim 21, wherein each of the resource types comprises one of a personnel type, a vehicle type, and an equipment type.

25. The CAD system of claim 21, wherein the virtual unit is created by selecting the one or more resource types required for the transfer event from a list of resource types.

26. The CAD system of claim 25, wherein the web server presents a plurality of web pages that enable one or more system administrators to configure the resource types on the list.

27. The CAD system of claim 21, wherein the virtual unit is rostered by selecting the one or more of the emergency services resources from a list of available emergency services resources.

28. The CAD system of claim 27, wherein the emergency services resources in the rostered unit are assigned on the fly to the transfer event.

29. The CAD system of claim 27, wherein the available emergency services resources on the list do not contain a restriction on availability in relation to the transfer event.

30. The CAD system of claim 29, wherein the restriction on availability comprises one of a geographic restriction, a time restriction, a qualification restriction, and combinations thereof.
